(19) United States
(12) Patent Application Publication
(10) Pub. No.: US 2025/0298710 A1
(43) Pub. Date: Sep. 25, 2025

(54) TIME-BASED PARAMETER OPTIMIZATION AND ATTRIBUTION MODELING FOR DISPARATE COMPUTING ENTITIES WITH A SHARED COMPUTING ECOSYSTEM

(71) Applicant: Optum, Inc., Minnetonka, MN (US)

(72) Inventors: Paul GODDEN, London (GB); Rahul Kumar GOYAL, Phoenix, AZ (US); Daniel George McCREARY, St. Louis Park, MN (US); Russell Henry AMUNDSON, Johns Island, SC (US); Sheryl Robin SKOLNICK, Livingston, NJ (US)

(21) Appl. No.: 18/612,510

(22) Filed: Mar. 21, 2024

(51) Int. Cl. G06F 11/273

(52) U.S. Cl. CPC G06F 11/273

(57) ABSTRACT

Various embodiments of the present disclosure provide parameter optimization and collaborative networking techniques for improving traditional disparate computing ecosystem. The techniques may include identifying a condition-specific entity cohort for a data entity that is associated with (i) a condition and (ii) a primary computing entity within a computing entity ecosystem. The techniques include generating a real-time optimization model for the condition using the condition-specific entity cohort and, using the real-time optimization model, generating an optimized entity parameter sequence for the data entity. The techniques include initiating the performance of a prediction-based action and, responsive to the prediction-based action, may include receiving a parameter modification for the data entity, generating a simulated recovery feature for the data entity, and provide access to data indicative of the simulated recovery feature to the computing entity ecosystem.

### BACKGROUND

Various embodiments of the present disclosure address technical challenges related to subjective parameter optimization and cross-platform collaboration techniques. In traditional prediction domains, parameter sequences may be arranged and assigned to an individual using various predictive techniques to optimize a particular sequence to the individual. While the parameters vary depending on the use case, generally, traditional predictive techniques may optimize the sequence of parameters based on a target goal and historical data. In such cases, the value of a particular sequence of parameters is defined and capable of objective measurement. Traditional predictive techniques therefore rely on objective measurements and fail to accurately perform subjective predictions that require consideration of a contextual factors, such as an individual's quality of life, to understand the actual value of a prediction. For example, in a healthcare domain, a parameter sequence may include a set of treatments for treating a complex condition. Each set of potential treatments may have (i) a subjective impact on an individual's quality of life and (ii) an objective total cost of care for the individual. In such a case, an optimal set of potential treatments for an individual may require an understanding of the subjective impact on an individual's quality of life, which is traditionally challenging to measure.

Even if measured correctly, modifying a parameter for an individual, for example by performing a new treatment, may be initially costly, with delayed benefits that may not be realized by the entity that modifies the parameter. This conundrum exists in the healthcare industry when certain costly interventions, such as tier two drugs, gene therapy, or any other curative treatment, are front-loaded and are paid for by first payer to improve an individual's future quality of life, while down-stream savings from reduction in disease progression, resultant disability, improved quality of life, and/or the like may be captured by second payer. One such example includes spinal muscular atrophy that is (i) curable by a single dose of Zolgensma with a front-loaded cost of 2.9 million or (ii) manageable with multiple lifetime doses of Spinraza with downstream costs of 320,000 four times a year. Due to a lack of network connectivity between computing entities within a multi-payer ecosystem, benefits captured by a subsequent payer cannot be captured by a previous payer that is directly responsible for the benefit. This lack of cross-platform collaboration increases risks associated with a set of parameters and complicates the understanding of an optimal set of parameters for an individual.

Various embodiments of the present disclosure make important contributions to traditional parameter optimization and cross-entity collaboration techniques by addressing these technical challenges, among others.

### BRIEF SUMMARY

Various embodiments of the present disclosure provide improved parameter optimization and cross-platform collaboration techniques to enable automated and subjective parameter optimization as well as network connectivity across various entities within a computing ecosystem. To do so, some embodiments of the present disclosure provide a parameter optimization process for modelling a complex parameter space based on temporal data associated with a plurality of data entities within a prediction domain. Using the modeling techniques of the present disclosure, the complex parameter space may be solved for a particular data entity based on one or more subject considerations for the data entity, such as an estimated quality of life, risk tolerance, and/or the like. By doing so, an optimized parameter sequence may be generated for a data entity that is (i) reflective of a set of parameters that most efficiently achieve the subjective considerations of the entity and (ii) may be extrapolated to understand a future impact to the data entity. Some of the embodiments of the present disclosure leverage these new understandings and cross-platform collaboration techniques to facilitate the performance of an optimized parameter sequence. To do so, some embodiments of the present disclosure, may generate transferable tokens that are reflective of a future impact on a data entity that is directly caused by a first computing entity. These tokens may be assigned to the first computing entity and published to an entire ecosystem of collaborating computing entities. This, in turn, enables a first computing entity to recapture future positive impacts resulting from a parameter modification. In this way, the techniques of the present disclosure remove risk constraints that traditionally hinder the performance of optimal parameter sequences, while enabling cross-platform collaboration within a traditionally disparate computing ecosystem.

In some embodiments, a computer-implemented method includes identifying, by one or more processors, a condition-specific entity cohort for a data entity that is associated with (i) a condition and (ii) a primary computing entity within a computing entity ecosystem; generating, by the one or more processors, a real-time optimization model for the condition based on (i) a plurality of outcome-time features, (ii) a plurality of entity attribute sequences, and (iii) a plurality of entity parameter sequences corresponding to the condition-specific entity cohort; generating, by the one or more processors and using the real-time optimization model, an optimized entity parameter sequence for the data entity; initiating, by the one or more processors, the performance of one or more prediction-based actions based on the optimized entity parameter sequence; and responsive to the one or more prediction-based actions, receiving one or more parameter modifications for the data entity based on the optimized entity parameter sequence; generating, using the real-time optimization model, a simulated recovery feature for the data entity based on the one or more parameter modifications; and providing access to data indicative of the simulated recovery feature to the computing entity ecosystem.

In some embodiments, a computing system includes memory and one or more processors communicatively coupled to the memory, the one or more processors are configured to identify a condition-specific entity cohort for a data entity that is associated with (i) a condition and (ii) a primary computing entity within a computing entity ecosystem; generate a real-time optimization model for the condition based on (i) a plurality of outcome-time features, (ii) a plurality of entity attribute sequences, and (iii) a plurality of entity parameter sequences corresponding to the condition-specific entity cohort; generate, using the real-time optimization model, an optimized entity parameter sequence for the data entity; initiate the performance of one or more prediction-based actions based on the optimized entity parameter sequence; and responsive to the one or more prediction-based actions, receive one or more parameter modifications for the data entity based on the optimized entity parameter sequence; generate, using the real-time optimization model, a simulated recovery feature for the data entity based on the one or more parameter modifications; and provide access to data indicative of the simulated recovery feature to the computing entity ecosystem.

In some embodiments, one or more non-transitory computer-readable storage media include instructions that, when executed by one or more processors, cause the one or more processors to identify a condition-specific entity cohort for a data entity that is associated with (i) a condition and (ii) a primary computing entity within a computing entity ecosystem; generate a real-time optimization model for the condition based on (i) a plurality of outcome-time features, (ii) a plurality of entity attribute sequences, and (iii) a plurality of entity parameter sequences corresponding to the condition-specific entity cohort; generate, using the real-time optimization model, an optimized entity parameter sequence for the data entity; initiate the performance of one or more prediction-based actions based on the optimized entity parameter sequence; and responsive to the one or more prediction-based actions, receive one or more parameter modifications for the data entity based on the optimized entity parameter sequence; generate, using the real-time optimization model, a simulated recovery feature for the data entity based on the one or more parameter modifications; and provide access to data indicative of the simulated recovery feature to the computing entity ecosystem.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a dataflow diagram showing example data structures and modules for generating and initiating an optimized entity parameter sequence in accordance with some embodiments discussed herein.

FIG. 5 is an operational example of an entity attribute sequence in accordance with some embodiments discussed herein.

FIG. 6 is an operational example of a recovery attribution ecosystem in accordance with some embodiments discussed herein.

FIG. 7 is a flowchart diagram of an example process for generating and initiating an optimized entity parameter sequence in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

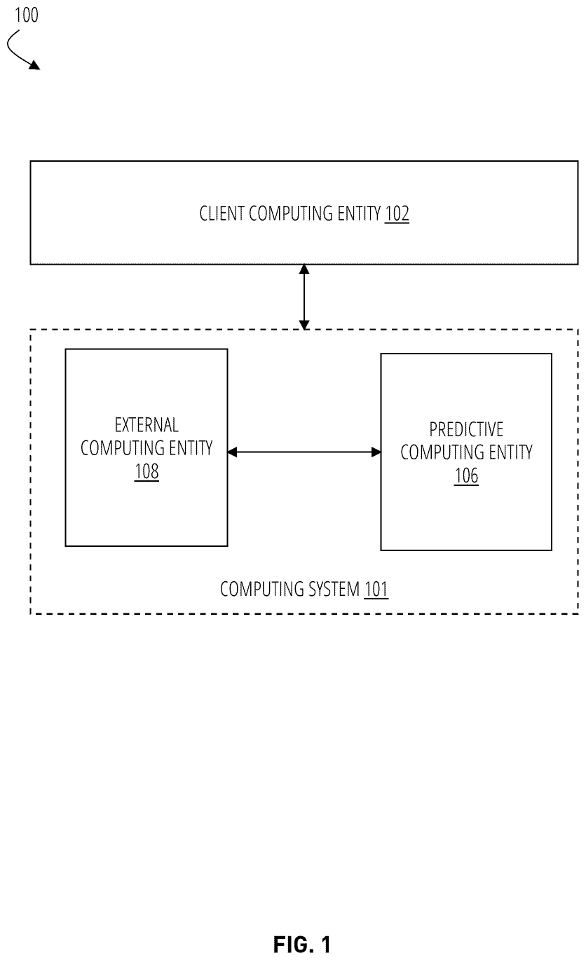

FIG. 1 provides an example overview of an architecture 100 in accordance with some embodiments of the present disclosure. The architecture 100 includes a computing system 101 configured to receive request, such as generative text requests, from client computing entities 102, process the requests to generate generative text outputs, and provide the generated text outputs to the client computing entities 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, one or more models may be trained and/or configured to generate one or more classifications, parameter sequences, parameter modifications, correction attributes, simulated recovery features, recovery attribution tokens, and/or the like. The models may form a machine learning pipeline that may be configured to automatically generate optimized parameter sequences and/or parameter modifications, leverage the optimized parameter sequences and/or parameter modifications to generate simulated recovery features, and then assign recovery attribution tokens based on the simulated recovery features. This technique will lead to more accurate and reliable parameter optimization techniques that may be efficiently used for a diverse set of different cases.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive requests from client computing entities 102, process the requests to generate outputs, such as optimized parameter sequences, and/or the like, and provide the generated outputs to the client computing entities 102. By way of example, the predictive computing entity 106 may host one or more microservices that may be accessible by the client computing entities 102 and/or external computing entities 108. In such a case, the predictive computing entity 106 may perform one or more operations of the present disclosure through one or more prompts, requests, API calls, and/or the like that are received from the client computing entities 102 and/or external computing entities 108.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. The data, for example, may include a graph-based data structure (or any other data structure) that is individually managed by the predictive computing entity 106 and/or collectively managed by the predictive computing entity 106 and/or the one or more external computing entities 108. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., parameter optimization techniques, classification techniques, simulation techniques, and/or the like) described herein. The external computing entities 108, for example, may include and/or be associated with one or more entities that may be configured to receive, transmit, store, manage, and/or facilitate datasets, such as the document data store, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data, etc.) from the use of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

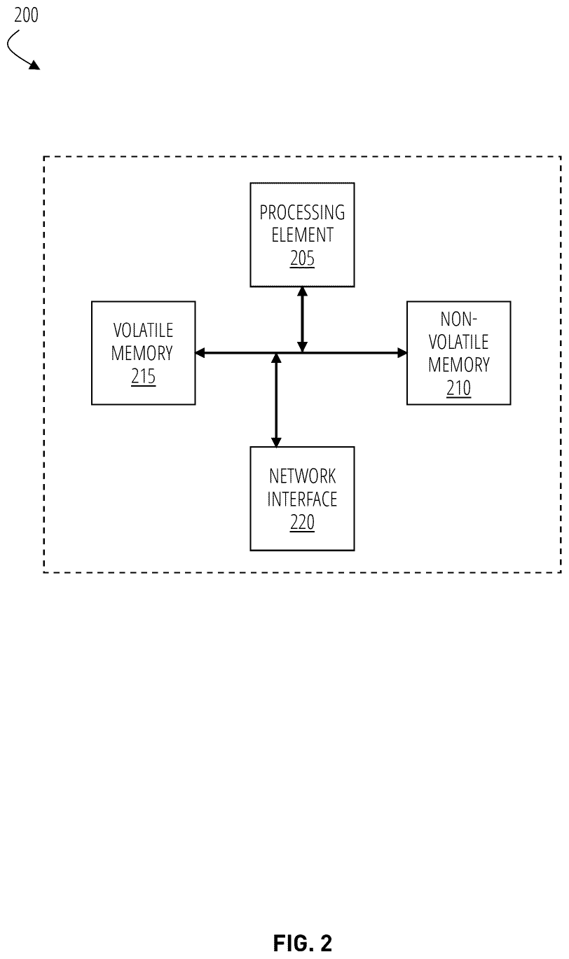

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

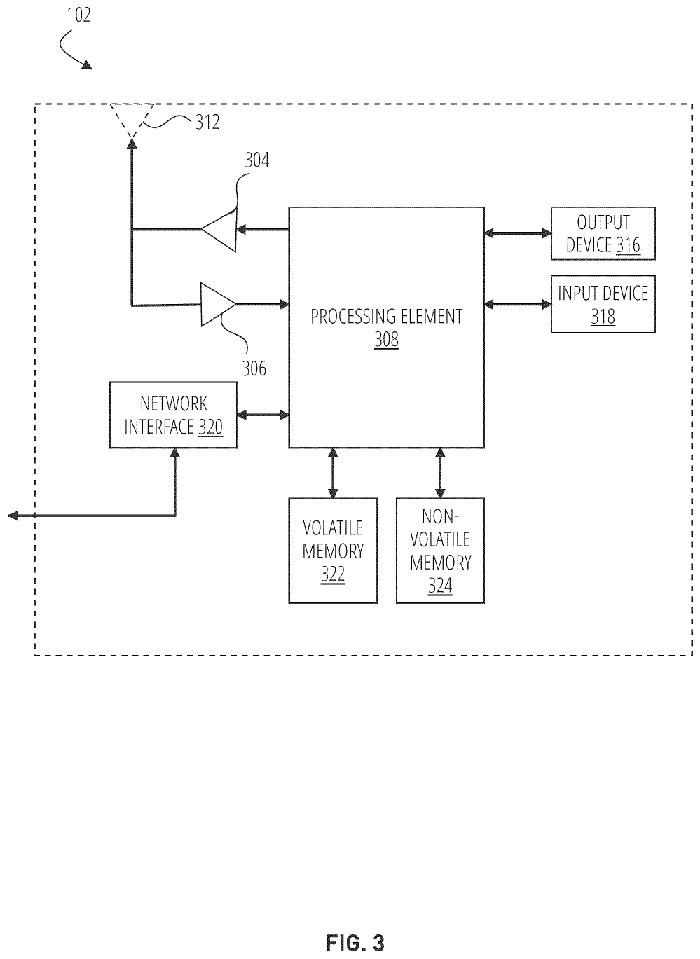

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “data entity” refers to a data element that describes a single entity within a prediction domain. A data entity may depend on the prediction domain. For example, in a healthcare domain, the data entity may correspond to an individual patient.

A data entity may be associated with a plurality of attributes that are based on the prediction domain. Each attribute may be reflective of a characteristic that is recorded for the prediction domain. For instance, using the healthcare domain example, an attribute may be one or more healthcare conditions diagnosed for a patient, one or more treatment regimens prescribed for the patient, one or more times or locations associated with a last treatment, and/or any other health- or patient-related information. In some examples, the plurality of attributes of a data entity may form an entity attribute sequence.

In some embodiments, the term “entity attribute sequence” refers to a set of attributes that correspond to a data entity. An entity attribute sequence may include a plurality of time-based attributes for a data entity. The time-based attributes may depend on a prediction domain. Using a healthcare prediction domain as an example, an entity attribute sequence may include a plurality of characteristics associated with a sequence of clinical encounters. The characteristics, for example, may describe one or more treatments, diagnoses, costs, disease progressions, and/or the like during the clinical encounter.

In some embodiments, an entity attribute sequence is extracted from a domain data structure.

In some embodiments, the term “domain data structure” refers to a data structure that describes a plurality of data entities within a prediction domain. A domain data structure may include any type of data structure stored in a centralized and/or distributed memory. In some examples, the domain data structure may include a graph database. In addition, or alternatively, the domain data structure may include a structure query language (SQL) database, columnar database, a relational database, and/or the like. In some examples, the domain data structure may include a distributed ledger-based database, such a blockchain ledger that may leverage a voting mechanism to post data entities (and/or attributes thereof) to a shared data structure. For example, the domain data structure may include a distributed, federated, centralized, and/or any other form of data structure.

In some examples, the domain data structure may include a graph-based data structure and an entity-attribute sequence may be extracted by traversing the graph-based data structure for a data entity.

In some embodiments, the term “graph-based data structure” refers to a data structure that describes a plurality of data entities within a prediction domain. The data structure, for example, may persist data in a form of items linked by their relationship to one another. The building blocks of the graph-based data structure may include nodes and edges where nodes are the vertices and edges are the links that connect the nodes. By way of example, a graph-based data structure may include a data structure, such as an undirected and acyclic graph with a plurality of nodes and edges. In some examples, the nodes and edges of the graph-based data structure be generated based on data from each of a plurality of source tables and/or interaction data objects for a prediction domain. For instance, source table data (e.g., patient attributes, encounter attributes, enterprise attributes, plan attributes, investigation attributes, etc., for a clinical domain) may be aggregated to construct the graph-based data structure. In some examples, a graph-based data structure is specific to a prediction domain and aggregates data from a plurality of different computing entities within a computing entity ecosystem of the prediction domain. In addition, or alternatively, the graph-based data structure may be specific to a particular computing entity.

In some embodiments, a graph-based data structure defines a plurality of graph nodes and edges. Each of the graph nodes, for example, may correspond to an entity within a prediction domain, such as a data entity (e.g., a patient in a healthcare domain, etc.) and/or one or more time-based entity encounters (e.g., healthcare visits in a healthcare domain, etc.) in a prediction domain. Each of the edges may connect at least two graph nodes and correspond to a relationship between the two graph nodes. In this manner, using a healthcare domain as an example, a graph-based data structure may capture health insurance data in the form of a heterogenous graph network by generating a plurality of connected patient and clinical encounter nodes from attributes sourced from clinical encounters between a patient and a healthcare provider. In some examples, in addition to the attributes from the clinical encounters, a graph-based data structure may include derived data, such as a member's age (e.g., from a date of birth attribute, etc.), geographic distances (e.g., from between employer and member locations, etc.), and/or open source information, such as a geographic location's population, mean age, cost of living, etc., a company's size, industry, revenue, etc., an insurance plan or coverage type, and/or the like.

In some embodiments, the graph-based data structure provides for diverse data elements to be linked to each other in cogent relationships and represented visually in a way that proximity of the elements demonstrates the tightness of the relationship between them. For example, a patient's home address and their next-door neighbor's home address may be represented as closely linked, while the link between a patient's home address and phone number may show a closer proximity to the member's home address than to the neighbor's. In some examples, graph nodes that are linked may include demographic data, health information data including medications, prior treatments, claims and cost data and information about healthcare providers.

In some embodiments, the graph-based data structure includes a plurality of graph nodes that respectively represent healthcare transactions and relationships between the data entities involved in those transactions. For example, the edges between two graph nodes may represent associations and/or actions between two entities (e.g., a patient, healthcare provider, insurance platform, etc.). The edges may include edge attributes corresponding to a particular relationship between two entities. In some examples, the graph-based data structure may include a layered structure—where a lower-level transactional representation may be summarized and represented by an enhanced structure overlayed on the same graph and in this summarized structure weights (e.g., metrics associated with a lower-level transaction) may be attached to both graph edges and graph nodes.

In some embodiments, the term “graph node” refers to a component of a graph-based data structure that describes an entity within a prediction domain. A graph node, for example, may include a vertex of the graph-based data structure that corresponds to an entity within the prediction domain. The entity may depend on the prediction domain. For example, in a healthcare domain, the graph node may describe a patient, a clinical encounter, a healthcare provider, an insurance platform, and/or one or more components thereof. Each graph node may be associated with a plurality of node attributes that correspond to a data entity.

In some embodiments, the term “graph edge” refers to a component of a graph-based data structure that describes a relationship within a prediction domain. A graph edge, for example, may connect two graph nodes of the graph-based data structure based on a defined relationship within the prediction domain. For example, the graph nodes of the graph-based data structure may be connected via various types of relationships that may be expressed using a plurality of graph edges. In some examples, the defined relationships may depend on the prediction domain. For example, in a healthcare domain, a graph edge may describe one or more healthcare-related relationships, such a familial relationship, legal relationships, healthcare provider relationships, a prescription relationship, and/or the like.

In some embodiments, the term “condition” refers to an attribute of a data entity that describes a characteristic with a recorded impact on an outcome-time feature for a data entity. A condition, for example, may describe an attribute that may increase or decrease an outcome-time feature over time. As an example, in a healthcare domain, an outcome-time feature may be a total cost of care for a patient and a condition may be a healthcare diagnosis that may increase a total cost of care for the patient over time. For example, a condition may be a healthcare diagnosis for a complex disease that may have a number of different treatment options with varying impacts on an immediate and total cost of care for a patient. By way of example, a condition may include multiple sclerosis, which has relatively low-cost primary drug regimens that could be replaced with more effective secondary or tertiary drug regimens at increased cost. As another example, a secondary or tertiary drug regimen may curative, whereas a low-cost primary drug regimen may be a maintenance therapy. Such drug regimens are examples of different potential entity parameter sequences for a data entity with a particular condition.

In some embodiments, the term “entity parameter sequence” refers to a subset of entity attributes that correspond to one or more remedial measures for a condition. An entity parameter sequence, for example, may describe one or more actions, tasks, and/or the like that are defined within a prediction domain and have a positive impact on a condition. Continuing the healthcare domain example, an entity parameter sequence may include a treatment plan that is assigned to a patient for a condition. A treatment plan, for example, may include one or more procedures, drug regimens, and/or the like for managing, remediating, and/or otherwise facilitating a patient's quality of life despite the condition.

In complex care cases, an optimized entity parameter sequence for a condition may be data entity (e.g., patient) specific. For instance, a change in therapy may occur for a data entity diagnosed with multiple sclerosis in the event that biomarkers or image analysis revealed evidence of disease progression despite a clinically stable symptom presentation. Each change in an entity parameter sequence may impact an outcome-time feature at a particular point in time and may have a predicted future impact on the outcome-time feature or a future point in time. For instance, a change in drug regimen may create a “front-loaded” cost that may continue for several years. However, over a protracted period, measured in decades, this more effective and costly drug regimen may decrease disease progression and the costs associated with it, such as from exacerbations of poorly controlled disease resulting in emergency department use, hospital admissions, acute care drug interventions and imaging, and/or the like. Moreover, disease progression, particularly for a disease impacting the function of the nervous system, may result in functional impairments that may result in disability, unemployability and a need for supportive care whether in-home or institutional. Such disability not only results in increased medical expenditures but also personal economic loss and significant deterioration in quality of life. In this way, a change in an entity parameter sequence may negatively impact an outcome-time feature at a particular point in time, while positively impacting the outcome-time feature at a future point in time.

In some embodiments, a data entity is associated with different computing entities over time that may shift responsibility for the outcome-time feature over periods of time. In such a case, one computing entity that is associated a data entity at the particular time may encounter the negative impact to the outcome-time feature, but not encounter the future positive impact on the outcome-time feature.

In some embodiments, the term “computing entity” refers to computing resource that is owned, operated, and/or otherwise associated with a primary entity for a plurality of data entities with a prediction domain. A computing entity, for example, may include one of a plurality of computing entities within a computing entity ecosystem.

In some embodiments, the term “computing entity ecosystem” refers to a plurality of computing entities within a prediction domain. A computing entity and computing entity ecosystem depend on the prediction domain. In an example healthcare domain, the computing entity ecosystem may correspond to a plurality of healthcare insurance platforms respectively operated by a different insurance provider, plan, and/or the like. In such a case, each computing entity may correspond to an at least partially distinctly operated healthcare insurance platform.

In some embodiments, the term “current primary entity” refers to a data element that describes a primary entity with a current relationship with a data entity. By way of example, in a healthcare domain, a current primary entity may include a healthcare insurance platform that is currently (e.g., at a current time) primary payer for medical claims corresponding to a data entity.

In some embodiments, the term “subsequent primary entity” refers to a data element that describes a primary entity with a subsequent relationship with a data entity. By way of example, in a healthcare domain, a subsequent primary entity may include a healthcare insurance platform that is subsequently (e.g., at a time after the current primary entity) assigned as a primary payer for medical claims corresponding to a data entity.

In some embodiments, the term “relationship modification” refers to a change between a current primary entity and a subsequent primary entity. For example, in a healthcare prediction domain, a relationship modification may be a change in benefits from one insurance provider to another insurance provider.

Due to the ability to perform relationship modifications, negative impacts to an outcome-time feature of a data entity may be encountered by a current primary entity without encountering the future positive impacts on the outcome-time feature that are a direct result of an action performed by the current primary entity. For example, continuing the healthcare example, future medical, financial, and quality-of-life deteriorations may be averted by modifying an entity parameter sequence for a data entity. These savings may come at an initial cost to the current primary entity, while benefitting a subsequent primary entity. This may create a “someone pays now for someone else saves later” conundrum that may have a negative impact on optimal entity parameter sequences for a data entity. Some embodiments of the present disclosure are directed to technical advances for addressing this challenge.

In some embodiments, the term “condition-specific entity cohort” refers to a plurality of data entities within a prediction domain that are associated with a common attribute. The common attribute, for example, may include a common condition, such as a complex medical condition that is associated with one or more different entity parameter sequences. In some examples, a condition-specific entity cohort may be identified by traversing a graph-based data structure. For instance, one of the attributes of graph-based data structure may be the ability to generate a cohort of data entities having similar entity attributes, such as a common condition, and comparing that cohort to another cohort of data entities with different attributes. Using a healthcare prediction domain as an example, a condition-specific entity cohort may include cohort of patients with Multiple Sclerosis. The cohort of patients may be associated with one or more different entity parameter sequences for the condition. A first subset, for example, may be associated with a first disease modifying therapy/drug regimen and a second subset may be associated with a second disease modifying therapy/drug regimen.

In some embodiments, a condition-specific entity cohort is identified using one or more graph queries to the graph-based data structure. In some examples, the condition-specific entity cohort may be filtered to remove one or more duplicate data entities. For instance, for each data entity in a base condition-specific entity cohort, an identity verification service may be called to confirm the identity of the data entity (e.g., using a universal identifier, such as globally unique identifier (GUID)). A data entity may be removed from the condition-specific entity cohort in the event that the identity is not confirmed.

In some embodiments, the term “outcome-time feature” refers to an attribute that describes a target feature of a data entity. An outcome-time feature may depend on a prediction domain. Using the example healthcare prediction domain, an outcome-time feature may include a total cost of care for a data entity. In some examples, the outcome-time feature may be determined from a start date of a condition. For instance, the outcome-time feature may include a total cost of care starting from a diagnosis of a healthcare condition.

In some embodiments, an outcome-time feature is generated for each data entity within a condition-specific cohort. In some examples, the outcome-time feature may be generated by traversing a graph-based data structure. For example, for each validated, unique data entity within a condition-specific cohort, a graph traversal may be performed. In some examples, the graph traversal may begin at a start date of a condition for a data entity. For instance, the graph-based data structure may be traversed beginning at a start date of the condition and ending at a current time period. In a healthcare prediction domain, one or more graph edges corresponding to a data entity may include cost information associated with one or more treatments after the diagnosis of a condition. These edges may be traversed to aggregate a cost of care from the index date of the diagnosis of the condition to a current time period.

In some examples, as a data entity's condition progresses, additional edges and nodes may be added to the graph-based data structure. In some examples, the state of the graph-based data structure may be monitored at a defined time frequency to dynamically update an outcome-time feature for a data entity.

In some embodiments, the term “defined time frequency” refers to a data element that describes a unit of time associated with an outcome-time feature. For example, data-driven refresh may be performed at a defined time frequency to update an outcome-time feature for a plurality of data entities. The defined time frequency may include a static, preset time period (e.g., quarterly). In addition, or alternatively, the defined time frequency may define one or more refresh criteria for triggering a data-driven refresh. For instance, the defined criteria may trigger a refresh in response to one or more entity parameter sequence modifications (e.g., administration of gene therapy, etc.), and/or the like.

In some embodiments, the term “temporal gap” refers to an unrecorded time period for a data entity. A temporal gap, for example, may include a period of time in which one or more attributes are missing from an entity attribute sequence. In some examples, a temporal gap may identify a gap in knowledge for a data entity. The gap in knowledge may be due to a number of different factors. As an example, in a healthcare domain, a temporal gap may identify a time period in which a patient is covered by a third-party insurance platform (or not covered at all).

In some embodiments, if a graph traversal identifies a temporal gap (e.g., missing graph nodes and/or graph edges over a period of time, etc.) with a data entity's entity attribute sequence, one or more correction attributes may be simulated to remediate the temporal gap.

In addition, or alternatively, in a healthcare prediction domain, an additional layer may be added to the graph-based data structure to represent a “slowly-changing” layer. This may permit additional refinement in identification of patients who may have a piecewise claims history because an employer, or Veteran's Association, etc., may potentially change less frequently than the data entity changes insurance platforms.

In some embodiments, the term “correction attribute” refers to a simulated attribute for a data entity. A correction attribute, for example, may include a simulated attribute for a temporal gap. In this manner, a plurality of correction attributes may be simulated to complete an entity attribute sequence by filling in one or more temporal gaps of the entity attribute sequence. A correction attribute may be generated using one or more interpolation techniques. The one or more interpolation techniques, for example, include generating correction attributes based on relative data entities and/or digital twins for the data entity.

In some embodiments, the graph-based data structure is expanded with a data entity standardized condition layer. The data entity standardized condition layer may represent a relative constant in a data entity's timeline (e.g., a healthcare journey, for example a Union or Veteran's Association). The relative constant may be aggregated from one or more time-based attributes corresponding to each data entity within a condition-specific entity cohort. In some examples, the one or more correction attributes for a data entity may be interpolated from the data entity standardized condition layer. By way of example, an automated agent may interpolate (e.g., by randomly and/or targeted sampling from the data entity standardized condition layer) one or more correction attributes for a data entity associated with one or more temporal gaps.

In addition, or alternatively, the one or more correction attributes may be interpolated from attributes of a plurality of related data entities and/or a digital twin to a data entity.

In some embodiments, the term “related data entity” refers to a different data entity with one or more attributes that are similar to an entity attribute sequence for a data entity. In some examples, a graph-specific interpolation methods may be leveraged to simulate one or more correction attributes for a data entity based on attributes associated with one or more related data entities. In a healthcare prediction domain, for example, the related data entities may include one or more attributes that exhibit a similar disease trajectory and/or treatment pattern (e.g., entity parameter sequence) to a data entity. In some examples, the attributes of the related data entities may be aggregated to simulate one or more correction attributes for the data entity. In some examples, the related data entities may be identified from a condition-specific entity cohort.

In some embodiments, the term “digital twin” refers to a third-party data entity that corresponds to a data entity. A digital twin, for example, may include a different data entity from a third-party data source that includes one or more attributes that are similar to the data entity. In some examples, a similarity threshold (e.g., a number and/or specific sequence of matching attributes, etc.) may be used to identify a digital twin and/or a related data entity. The similarity threshold may be higher (e.g., requiring a greater similarity) for a digital twin relative to a related data entity.

In some examples, using a digital twin approach, a third-party data source may be accessed to identify a digital twin for a data entity. Once identified, attributes may be interpolated from the digital twin to generate one or more correction attributes for the data entity.

In some embodiments, the term “third-party data source” refers to a data structure that includes a plurality of data entities that are separate from the plurality of data entities of the graph-based data structure. In a healthcare prediction domain, a third-party data source, for example, may include data from a Patient-Level Information Costing System (PLICS) associated with a National Health Service, and/or any other third-party healthcare surveying data source.

In some embodiments, the term “real-time optimization model” refers to statistical model with one or more rule-based and/or machine-learning layers configured to model one or more statistical relationships between a plurality of data entities within a condition-specific entity cohort at a particular point in time. In this respect, a real-time optimization model may correspond to a particular point in time for a condition-specific entity cohort and may be dynamically regenerated to accommodate for temporal changes within the condition-specific entity cohort. In some examples, a real-time optimization model may be generated based on a plurality of entity attribute sequences, a plurality of entity parameter sequences, and/or a plurality of outcome-time features respectively corresponding to a plurality of data entities within a condition-specific entity cohort.

A real-time optimization model may include any type of parameter optimization model, including simulated annealing models, pareto optimization models, and/or the like. As one example, a real-time optimization model may include a Markowitz model that is mapped to a plurality of entity attribute sequences, a plurality of entity parameter sequences, and/or a plurality of outcome-time features. To apply the Markowitz model, the entity attribute sequences and/or entity parameter sequences for a condition-specific cohort may be re-mapped to the outcome-time features. By way of example, the “portfolio” considered by a traditional Markowitz model may be mapped to an entity parameter sequence (e.g., a “portfolio” of treatments) and the risk-reward metric solved for by a traditional Markowitz model may be mapped to an outcome-time feature (e.g., representing a risk tolerance to quality-of-life metric). The aim is to assess the various treatment options (e.g., portfolio options in the original Markowitz model), with the idea to solve the Markowitz model and find the “maximum return portfolio,” the analogue in healthcare is the least risky, most cost-effective treatment that has the greatest likelihood of positive outcome for a patient.

By way of example, in the financial space, the Markowitz model offers a practical method for selecting investments in order to maximize their overall returns within an acceptable level of risk. The model may be mapped to the healthcare prediction domain by mapping the traditional investment vehicles to a selection of treatment and diagnostic options to maximize the total cost of care at the lowest level of acceptable risk for the patient. In both cases, the core concept is that risk and return/risk and outcome may be evaluated by how it affects the overall portfolio's/patient's risk and return/risk and outcome. In the healthcare prediction domain, the model may be built by: (i) determining a set of diagnostic and therapeutic options that are likely to be of most benefit to a patient with a condition and (ii) given the outputs of diagnostic information, select the treatment option with the best outcome and the lowest risk to the patient. In this case, an efficient frontier represents the best return/patient outcome for the lowest risk. The efficient frontier is determined by optimizing the weights of the efficient frontier given the constraints associated with the plurality of diagnostic and therapeutic options.

In some embodiments, the term “optimized entity parameter sequence” refers to an entity attribute sequence associated within a predicted optimal outcome-time feature for a data entity. In some examples, the optimized entity parameter sequence is generated (e.g., algorithmically, using one or more optimization models, etc.) by solving the real-time optimization model for a particular data entity. For instance, the optimized entity parameter sequence may include an entity attribute sequence that lies above an efficient frontier defined by a Markowitz model generated for a condition-specific entity cohort. In some examples, the optimized entity parameter sequence may represent the most cost-effective sequence of treatments for a data entity at a particular point in time that achieves a quality-of-life and risk tolerance threshold for the data entity.

In some embodiments, the term “prediction-based action” refers to a response to an optimized entity parameter sequence for a data entity. A prediction-based action may include a physical action, such as an automatic administration of a medical treatment (e.g., by automatically injecting a particular dosage of medication, such as insulin for a diabetic condition), a scheduling of a medical treatment, a facilitation of a prescription, and/or the like. In addition, or alternatively, a prediction-based action may include a computing operation, such as providing one or more instructions to automate a medical device (e.g., to record/transmit data in response to a parameter modification, etc.), initiating a display of information through a dynamic user interface (e.g., a recommendation to a physical through a physical portal, etc.), and/or the like. In some examples, the prediction-based action may initiate a physical action through a computing operation (e.g., by recommending a treatment to a physician, etc.). In some embodiments, in response to solving the real-time optimization model (e.g., finding an efficient frontier of a Markowitz model, etc.), a selected optimized entity parameter sequence (e.g., set of treatment options, etc.) may be made available to a provider computing entity, such as a clinical decision support (CDS) tool, to provide one or more treatment recommendations to a physician.

In some embodiments, the term “parameter modification” refers to a modification to a current entity parameter sequence for a data entity. A parameter modification, for example, may be performed to update a current entity parameter sequence for a data entity to an optimized entity parameter sequence for the data entity. In a healthcare prediction domain, for example, a parameter modification may include a performance of a new and/or modified set of treatments for a condition.

In some examples, the optimized entity parameter sequence and/or one or more parameter modification may be logged for a data entity by updating the domain data structure. As one example, for a graph-based data structure, the optimized entity parameter sequence and/or one or more parameter modifications may be logged for a data entity by modifying the domain-based data structure, such as by adding one or more graph to a graph-based data structure, posting a ledger entry to a distributed ledger-based data structure, and/or the like. In this manner, the parameter modifications may provide a feedback loop for refining future iterations of the real-time optimization model.

In some examples, the parameter modification and/or one or more resulting outcome-time features may be leveraged as ground truths for training a deep learning model through back-propagation of errors. In such a case, the efficient frontier of the real-time optimization model may include a feature engineered for the deep learning model configured to generate an optimized entity parameter sequence for a data entity based on an entity attribute sequence of the data entity. By way of example, the deep learning model may include a neural network, decision tree, and/or the like that may form a machine-learning pipeline with the real-time optimization model. The real-time optimization model may form a first, feature engineering layer of the machine-learning pipeline and the deep learning model may form a second, prediction layer of the machine-learning pipeline.

In some embodiments, the term “simulated recovery feature” refers to a predictive data element that describes a future positive impact to an outcome-time feature based on a parameter modification. A simulated recovery feature, for example, may describe one or more future costs that are avoided by a parameter modification. By way of example, in a healthcare prediction domain, a simulated recovery feature may describe a future reduction in a total cost of care due to a medical treatment or intervention.

In some embodiments, a simulated recovery feature is aggregated from the condition-specific entity cohort. For example, the simulated recovery features may be generated based on historical positive impact correlated to a particular parameter modification. In some examples, the historical positive impact may be aggregated from a plurality of granular, time-based, cost avoidance events (e.g., a future treatment avoided by an earlier treatment, etc.). In some examples, the simulated recovery feature may include a plurality of potential recovery features respectively corresponding to the granular, time-based, cost avoidance events.

In some embodiments, the term “recovery attribution token” refers to a data element that is assigned to a current primary entity in response to a parameter modification that results in one or more simulated recovery features. By way of example, a recovery attribution token may include a credit assigned to primary entity for data entity. In some examples, the recovery attribution token may be assigned for each of a plurality of granular, time-based, cost avoidance events. In some examples, the recovery attribution token may initiate a value transfer in the event that a particular granular, time-based, cost avoidance event is avoided for a particular data entity while a subsequent primary entity is responsible for the data entity. The recovery attribution token may include any data type capable of reflecting a credit for a particular entity. By way of example, the recovery attribution token may include a secure file share with a ledger, spreadsheet, and/or the like.

### IV. OVERVIEW

Various embodiments of the present disclosure provide parameter optimization and cross-entity collaboration techniques that improve the collaboration and predictive capability of traditional computing ecosystems. To do so, some embodiments of the present disclosure provide a parameter optimization process for modelling a complex parameter space based on temporal data associated with a plurality of data entities within a prediction domain. As described herein, the parameter optimization process may expand the capabilities of traditional modeling techniques by remapping parameters and statistical assumptions traditionally used in some prediction domains to new, previously unanalyzed prediction domains. By doing so, an optimized parameter sequence may be generated that is tailored to a data entity within the new prediction domain. The optimized parameter sequence may be leveraged, using cross-platform network communications, to predict and tokenize future positive impacts that may directly or indirectly result from actions performed within a current time period. Some of the embodiments of the present disclosure integrate these new data structures into a cross-platform message sharing ecosystem to facilitate collaboration between traditionally disparate computing entities within the ecosystem.

In some embodiments, some of the techniques of the present disclosure leverage graph-based data structures and graph traversal operations to identify cohorts of data entities tailored to a particular condition. Temporal attributes from the resulting condition-specific entity cohort may be used to generate a real-time optimization model for the condition that maps a plurality of potential parameters, such as medical treatments, to temporal events in the life of each of the data entities within the condition-specific entity cohort. The real-time optimization model may be time-specific and adjust over time to continuously accurately model a parameter space for the condition. In some embodiments, the real-time optimization model is a Markowitz model that is remapped to solve technical challenges in other prediction domains, such as the healthcare industry. For example, the applicability of a Markowitz model may be expanded from a traditional financial setting to a healthcare setting by mapping the optimization of a healthcare decision to a financial portfolio optimization. This enables an improved Markowitz model that is remapped for a healthcare prediction domain. The Markowitz model may be solved for each of a plurality of different data entities to generate optimized entity parameter sequences. Quality may be controlled by ensuring that each optimized entity parameter sequence lies above an efficient frontier defined by the model. In this way, traditional portfolio management techniques may be augmented and remapped to a healthcare setting to enable the subjective optimization of treatments for complex healthcare conditions. This, in turn, improves parameter optimization within a healthcare domain by improving traditional Markowitz models.

Moreover, some embodiments of the present disclosure may leverage insights from a graph-based data structure, the Markowitz model, or optimized parameter sequences across a plurality of data entities to simulate and tokenize future positive impacts from real-time decision making. This allows benefits resulting from a present decision to be recaptured by the entity involved with the present decision. For example, a simulated recovery feature may be generated for the data entity based on a parameter modification, such as a modification to a treatment plan for a patient. Data indicative of the simulated recovery feature may then be provided a computing entity ecosystem to collaboratively support the present decision. For example, using a healthcare prediction domain for illustration, savings from a particular medical intervention may be simulated using an attribution model that may predict the savings for an individual over time that directly (or indirectly) result from the medical intervention.

By attributing savings to a particular medical intervention, the attribution model may serve to enhance a patient's ability to receive costly interventions for rare and chronic degenerative diseases, such as Spinal Muscular Atrophy, Hemophilia, Alzheimer's Disease, Multiple Sclerosis, and/or the like, by tracking benefits of the costly interventions over time and allowing the original payer to recapture these benefits. For instance, some techniques of the present disclosure may accurately track costs across time and attribute savings to a payer that has provided higher cost and greater efficacy treatments to promote better disease control by removing cost barriers to costly interventions.

Examples of technologically advantageous embodiments of the present disclosure include: (i) subjective parameter optimization techniques, (ii) cross-platform communication techniques, and (iii) cross-entity parameter modification collaboration techniques, among other aspects of the present disclosure. Other technical improvements and advantages may be realized by one of ordinary skill in the art.

### V. EXAMPLE SYSTEM OPERATIONS

As indicated, various embodiments of the present disclosure make important technical contributions to parameter optimization and cross-platform collaboration techniques. In particular, systems and methods are disclosed herein that implement parameter optimization techniques to improve the efficacy of optimized entity parameter sequences. By doing so, improved optimized entity parameter sequences may be generated and expanded to allow for collaboration across multiple disparate computing entities within a computing ecosystem.

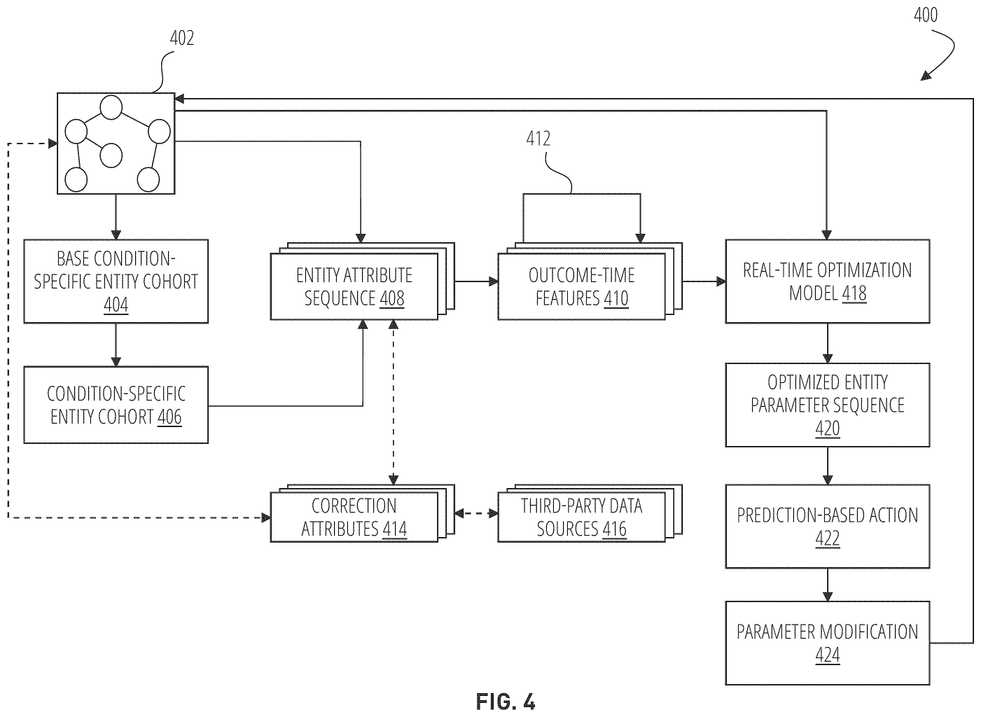

FIG. 4 is a dataflow diagram 400 showing example data structures and modules for generating and initiating an optimized entity parameter sequence in accordance with some embodiments discussed herein. The dataflow diagram 400, for example, illustrates a multi-stage entity processing pipeline for identifying an optimized entity parameter sequence from a parameter space including a plurality of different parameter combinations. As described herein, the multi-stage entity processing pipeline may leverage graph-based techniques to efficiently extract and augment historical data for a prediction domain and, with the augmented historical data, model a parameter space for the prediction domain. The model of the parameter space may be solved for a particular data entity to identify an optimized entity parameter sequence 420 for the data entity at a particular point in time. The optimized entity parameter sequence 420 may be leveraged to initiate and track prediction-based actions 422 for a data entity. By doing so, a graph-based data structure 402 and real-time optimization model 418 may be continuously updated over time to adapt to real time changes within a prediction domain. This, in turn, leads to improved, time-based predictions and enables accurate modelling and attribution techniques that allow for the establishment of collaborative parameter modifications across different computing entities over time. As described herein, such parameter modifications may result in improved, domain-wide techniques for handling conditions, such a complex healthcare conditions, exhibited by a data entity within a prediction domain.

To do so, in some embodiments, a condition-specific entity cohort 406 for a data entity is identified that is associated with (i) a condition and (ii) a primary computing entity within a computing entity ecosystem. In some examples, the condition-specific entity cohort 406 includes a plurality of data entities that are associated with the condition. In some examples, each of the plurality of entity attribute sequences 408 may correspond to one or more patient characteristics of a particular data entity within the condition-specific entity cohort 406 at a particular time. In some examples, each of the plurality of entity parameter sequences may correspond to a treatment plan to remediate the condition for the particular data entity at the particular time. In some examples, each of the plurality of outcome-time features 410 corresponds to a total cost of care for the particular data entity at the particular time.

In some embodiments, the condition-specific entity cohort 406 is identified based on a graph-based data structure 402 that comprises a plurality of graph nodes and each respective data entity of the condition-specific entity cohort 406 corresponds to a graph node of the graph-based data structure 402. In some examples, the outcome-time feature 410 for a particular data entity of the condition-specific entity cohort 406 is generated by traversing the graph-based data structure 402.

In some embodiments, a data entity is a data element that describes a single entity within a prediction domain. A data entity may depend on the prediction domain. For example, in a healthcare prediction domain, the data entity may correspond to an individual patient.

A data entity may be associated with a plurality of attributes that are based on the prediction domain. Each attribute may be reflective of a characteristic that is recorded for the prediction domain. For instance, using the healthcare domain example, an attribute may be one or more healthcare conditions diagnosed for a patient, one or more treatment regimens prescribed for the patient, one or more times or locations associated with a treatment, and/or any other health- or patient-related information. In some examples, the plurality of attributes of a data entity may form an entity attribute sequence 408.

In some embodiments, an entity attribute sequence 408 is a set of attributes that correspond to a data entity. An entity attribute sequence 408 may include a plurality of time-based attributes for a data entity. The time-based attributes may depend on a prediction domain. Continuing the healthcare prediction domain example, an entity attribute sequence 408 may include a plurality of characteristics associated with a sequence of clinical encounters. The characteristics, for example, may describe one or more treatments, diagnoses, costs, disease progressions, and/or the like during the clinical encounter.

In some embodiments, an entity attribute sequence 408 is extracted from a graph-based data structure 402 by traversing the graph-based data structure 402 for a data entity.

In some embodiments, the graph-based data structure 402 is a data structure that describes a plurality of data entities within a prediction domain. The graph-based data structure 402, for example, may persist data in a form of items linked by their relationship to one another. The building blocks of the graph-based data structure 402 may include graph nodes and graph edges where nodes are the vertices and edges are the links that connect the nodes. By way of example, a graph-based data structure 402 may include a data structure, such as an undirected and acyclic graph with a plurality of nodes and edges. In some examples, the nodes and edges of the graph-based data structure 402 be generated based on data from each of a plurality of source tables and/or interaction data objects for a prediction domain. For instance, source table data (e.g., patient attributes, encounter attributes, enterprise attributes, plan attributes, investigation attributes, etc. for a clinical domain) may be aggregated to construct the graph-based data structure 402. In some examples, a graph-based data structure 402 is specific to a prediction domain and aggregates data from a plurality of different computing entities within a computing entity ecosystem of the prediction domain. In addition, or alternatively, the graph-based data structure 402 may be specific to a particular computing entity.

In some embodiments, the graph-based data structure 402 defines a plurality of graph nodes and edges. Each of the graph nodes, for example, may correspond to an entity within a prediction domain, such as a data entity (e.g., a patient in a healthcare domain, etc.) and/or one or more time-based entity encounters (e.g., healthcare visits in a healthcare domain that include a time stamp, etc.) in a prediction domain. Each of the edges may connect at least two graph nodes and correspond to a relationship between the two graph nodes. In this manner, using a healthcare domain as an example, the graph-based data structure 402 may capture health insurance data in the form of a heterogenous graph network by generating a plurality of connected patient and clinical encounter nodes from attributes sourced from clinical encounters between a patient and a healthcare provider. In some examples, in addition to the attributes from the clinical encounters, the graph-based data structure 402 may include derived data, such as a patient's age (e.g., from a date of birth attribute, etc.), geographic distances (e.g., from between employer and patient locations, etc.), and/or open source information, such as a geographic location's population, mean age, cost of living, etc., a company's size, industry, revenue, etc., an insurance plan or coverage type, and/or the like.

In some embodiments, the graph-based data structure 402 provides for diverse data elements to be linked to each other in cogent relationships and represented visually in a way that proximity of the elements demonstrates the tightness of the relationship between them. For example, a patient's home address and their next-door neighbor's home address may be represented as closely linked, while the link between a patient's home address and phone number may show a closer proximity to the member's home address than to the neighbor's. In some examples, graph nodes that are linked include may include demographic data, health information data including medications, prior treatments, claims and cost data and information about healthcare providers.

In some embodiments, the graph-based data structure 402 includes a plurality of graph nodes that respectively represent healthcare transactions and relationships between the data entities involved in those transactions. For example, the edges between two graph nodes may represent associations and/or actions between two entities (e.g., a patient, healthcare provider, insurance platform, etc.). The edges may include edge attributes corresponding to a particular relationship between two entities. In some examples, the graph-based data structure 402 may include a layered structure—where a lower-level transactional representation may be summarized and represented by an enhanced structure overlayed on the same graph and in this summarized structure weights (e.g., metrics associated with a lower-level transaction) may be attached to both graph edges and graph nodes.

In some embodiments, a graph node a component of the graph-based data structure 402 that describes an entity within a prediction domain. A graph node, for example, may include a vertex of the graph-based data structure 402 that corresponds to an entity within the prediction domain. The entity may depend on the prediction domain. For example, in a healthcare domain, the graph node may describe a patient, a clinical encounter, a healthcare provider, an insurance platform, and/or one or more components thereof. Each graph node may be associated with a plurality of node attributes that correspond to a data entity.

In some embodiments, a graph edge refers to another component of the graph-based data structure 402 that describes a relationship within a prediction domain. A graph edge, for example, may connect two graph nodes of the graph-based data structure 402 based on a defined relationship within the prediction domain. For example, the graph nodes of the graph-based data structure 402 may be connected via various types of relationships that may be expressed using a plurality of graph edges. In some examples, the defined relationships may depend on the prediction domain. For example, in a healthcare domain, a graph edge may describe one or more healthcare-related relationships, such a familial relationship, legal relationships, healthcare provider relationships, a prescription relationship, and/or the like.

In some embodiments, a condition is an attribute of a data entity that describes a characteristic with a recorded impact on an outcome-time feature for a data entity. A condition, for example, may describe an attribute that may increase or decrease an outcome-time feature 410 over time. As an example, in a healthcare domain, an outcome-time feature 410 may be a total cost of care for a patient and a condition may be a healthcare diagnosis that may increase a total cost of care for the patient over time. For example, a condition may be a healthcare diagnosis for a complex disease that may have a number of different treatment options with varying impacts on an immediate and total cost of care for a patient. By way of example, a condition may include multiple sclerosis, which has relatively low-cost maintenance drug regimens that could be replaced with a curative secondary or tertiary drug regimens at increased cost. Such drug regimens are examples of different potential entity parameter sequences for a data entity with a particular condition.

In some embodiments, an entity parameter sequence is a subset of entity attributes that correspond to one or more remedial measures for a condition. An entity parameter sequence, for example, may describe one or more actions, tasks, and/or the like that are defined within a prediction domain and have a positive impact on a condition. Continuing the healthcare domain example, an entity parameter sequence may include a treatment plan that is assigned to a patient for a condition. A treatment plan, for example, may include one or more procedures, drug regimens, and/or the like for managing, remediating, and/or otherwise facilitating a patient's quality of life despite the condition.

In complex care cases, an optimized entity parameter sequence 420 for a condition may be data entity (e.g., patient) specific. For instance, a change in therapy may occur for a data entity diagnosed with multiple sclerosis in the event that biomarkers or image analysis revealed evidence of disease progression despite a clinically stable symptom presentation. Each change in an entity parameter sequence may impact an outcome-time feature 410 at a particular point in time and may have a predicted future impact on the outcome-time feature 410 are a future point in time. For instance, a change in drug regimen may create a “front-loaded” cost that may continue for several years. However, over a protracted period (e.g., measured in decades, etc.), this more effective and costly drug regimen may decrease disease progression and the costs associated with it, such as from exacerbations of poorly controlled disease resulting in emergency department use, hospital admissions, acute care drug interventions and imaging, and/or the like. Moreover, disease progression, particularly for a disease impacting the function of the nervous system, may result in functional impairments that may result in disability, unemployability and a need for supportive care whether in-home or institutional. Such disability not only results in increased medical expenditures but also personal economic loss and significant deterioration in quality of life. In this way, a change in an entity parameter sequence may negatively impact an outcome-time feature 410 at a particular point in time, while positively impacting the outcome-time feature 410 at a future point in time.

In some embodiments, a data entity is associated with different computing entities over time that may shift responsibility for the outcome-time feature 410 over periods of time. In such a case, one computing entity that is associated a data entity at the particular time may encounter the negative impact to the outcome-time feature 410, but not encounter the future positive impact on the outcome-time feature 410.

In some embodiments, the condition-specific entity cohort 406 is a plurality of data entities within a prediction domain that are associated with a common attribute. The common attribute, for example, may include a common condition, such as a complex medical condition that is associated with one or more different entity parameter sequences. In some examples, a condition-specific entity cohort 406 may be identified by traversing and/or querying the graph-based data structure 402. For instance, one of the attributes of graph-based data structure 402 may be the ability to generate a cohort of data entities having similar entity attributes, such as a common condition, and comparing that cohort to another cohort of data entities with different attributes. Using a healthcare prediction domain as an example, the condition-specific entity cohort 406 may include cohort of patients with Multiple Sclerosis. The cohort of patients may be associated with one or more different entity parameter sequences for the condition. A first subset, for example, may be associated with a first disease modifying therapy/drug regimen and a second subset may be associated with a second disease modifying therapy/drug regimen.

In some embodiments, the condition-specific entity cohort 406 is identified using one or more graph queries to the graph-based data structure 402. In some examples, the condition-specific entity cohort 406 may be filtered to remove one or more duplicate data entities. For instance, for each data entity in a base condition-specific entity cohort 404, an identity verification service may be called to confirm the identity of the data entity (e.g., using a universal identifier, such as globally unique identifier (GUID)). A data entity may be removed from the condition specific entity cohort in the event that the identify is not confirmed.

In some examples, an outcome-time feature 410 is generated for each data entity of the condition-specific entity cohort 406. For example, an outcome-time feature 410 of the plurality of outcome-time features may be generated for a particular data entity based on an entity attribute sequence 408 corresponding to the particular data entity.

In some embodiments, the outcome-time feature 410 is an attribute that describes a target feature of a data entity. An outcome-time feature 410 may depend on a prediction domain. Using the example healthcare prediction domain, the outcome-time feature 410 may include a total cost of care for a data entity. In some examples, the outcome-time feature 410 may be determined from a start date of a condition. For instance, the outcome-time feature 410 may include a total cost of care starting from a diagnosis of a healthcare condition.

In some embodiments, the outcome-time feature 410 is generated for each data entity within a condition-specific entity cohort 406. In some examples, the outcome-time feature 410 may be generated by traversing a graph-based data structure 402. For example, for each validated, unique data entity within a condition specific cohort, a graph traversal may be performed. In some examples, the graph traversal may begin at a start date of a condition for a data entity. For instance, the graph-based data structure 402 may be traversed beginning at a start date of the condition and ending at a current time period. In a healthcare prediction domain, one or more graph edges corresponding to a data entity may include cost information associated with one or more treatments after the diagnosis of a condition. These edges may be traversed to aggregate a cost of care from the index date of the diagnosis of the condition to a current time period.

In some examples, as a data entity's condition progresses, additional edges and nodes may be added to the graph-based data structure 402. In some examples, the state of the graph-based data structure 402 may be monitored at a defined time frequency 412 to dynamically update an outcome-time feature 410 for a data entity.

In some embodiments, the defined time frequency 412 is a data element that describes a unit of time associated with an outcome-time feature 410. For example, data-driven refresh may be performed at a defined time frequency 412 to update an outcome-time feature 410 for a plurality of data entities. The defined time frequency 412 may include a static, preset time period (e.g., quarterly). In addition, or alternatively, the defined time frequency 412 may define one or more refresh criteria for triggering a data-driven refresh. For instance, the defined criteria may trigger a refresh in response to one or more entity parameter sequence modifications (e.g., administration of gene therapy, etc.), and/or the like.

In some embodiments, a real-time optimization model 418 is generated for the condition based on (i) the plurality of outcome-time features 410, (ii) the plurality of entity attribute sequences 408, and/or (iii) a plurality of entity parameter sequences corresponding to the condition-specific entity cohort 406.

In some embodiments, the real-time optimization model 418 is a statistical model with one or more rule-based and/or machine-learning layers configured to model one or more statistical relationships between a plurality of data entities within the condition-specific entity cohort 406 at a particular point in time. In this respect, the real-time optimization model 418 may correspond to a particular point in time for the condition-specific entity cohort 406 and may be dynamically regenerated to accommodate for temporal changes within the condition-specific entity cohort 406. In some examples, the real-time optimization model 418 may be generated based on a plurality of entity attribute sequences 408, a plurality of entity parameter sequences, and/or a plurality of outcome-time features 410 respectively corresponding to a plurality of data entities within condition-specific entity cohort 406.

For example, the real-time optimization model 418 may include a Markowitz model that is mapped to a plurality of entity attribute sequences 408, a plurality of entity parameter sequences, and/or a plurality of outcome-time features 410. To apply the Markowitz model, the entity attribute sequences 408 and/or entity parameter sequences for the condition-specific entity cohort 406 may be re-mapped to the outcome-time features 410. By way of example, the “portfolio” considered by a traditional Markowitz model may be mapped to an entity parameter sequence (e.g., a “portfolio” of treatments) and the risk-reward metric solved for by a traditional Markowitz model may be mapped to an outcome-time feature 410 (e.g., representing a risk tolerance to quality-of-life metric). The aim is to assess the various treatment options (e.g., portfolio options in the original Markowitz model), with the idea to solve the Markowitz model and find the “maximum return portfolio,” the analogue in healthcare is the least risky, most cost-effective treatment that has the greatest likelihood of positive outcome for a patient.

By way of example, in the financial space, the Markowitz model offers a practical method for selecting investments in order to maximize their overall returns within an acceptable level of risk. The model may be mapped to the healthcare prediction domain by mapping the traditional investment vehicles to a selection of treatment and diagnostic options to maximize the total cost of care at the lowest level of acceptable risk for the patient. In both cases, the core concept is that risk and return/risk and outcome may be evaluated by how it affects the overall portfolio's/patient's risk and return/risk and outcome. In the healthcare prediction domain, the model may be built by: (i) determining a set of diagnostic and therapeutic options (e.g., parameters) that are likely to be of most benefit to a patient with a condition and (ii) given the outputs of diagnostic information, select the treatment option (e.g., an optimized entity parameter sequence 420) with the best outcome and the lowest risk to the patient.

For instance, the optimization task may be to minimize risk while maximizing return, which, in a healthcare domain, may be considered to be a compounding of patient outcomes and treatment costs (e.g., a quality of life). Patient outcomes, for example, may be mapped to return, and treatment costs may be mapped to risk. In some examples, additional costs for treating a complication, treating adverse responses, treating disease progression from ineffective first line therapy may be included as part of risk. In Markowitz theory, patient outcomes and treatment costs may be essentially a Capital Market Line (CML), which represents the optimally combined risk and return. From a computing entity's perspective, the CML may represent the line of maximum probability of retention of a patient on a health plan combined with the minimum necessary expenditure to achieve the best healthcare outcome for the patient's current condition.

In some examples, one or more assumptions of a Markowitz model may be remapped to a healthcare prediction domain by remapping: (1) the risk of the portfolio that is traditionally based on its volatility (and covariance) of returns to payer risks, such as (a) increased subsequent medical costs due to poor outcome, (b) regardless of outcome, the patient switches to another payer; (2) a single-period model of investment analysis to a single episodic case of illness; (3) an investor is rational (e.g., averse to risk and prefers to increase consumption, etc.) to outcome improvements; and (4) investor risk management (e.g., minimizing their risk for a given return or maximizing their portfolio return for a given level of risk, etc.) to risk management for a patient that maximizes the likelihood of the best possible outcome.

In this case, an efficient frontier represents the best return/patient outcome for the lowest risk. The efficient frontier is determined by optimizing the weights of the efficient frontier given the constraints associated with the plurality of diagnostic and therapeutic options (e.g., parameters). In some embodiments, the weights may be optimized using one or more Markowitz model solvers, such the Broyden-Fletcher-Goldfarb-Shanno solver for multivariate optimization problems with nonlinear constraints (BFGS) in SciPy, solveQPXT( ) from the quadprogXTR package, and/or the like.

In some embodiments, an optimized entity parameter sequence 420 is generated for the data entity using the real-time optimization model 418. As described herein, in some examples, the real-time optimization model 418 is a Markowitz Model. In such a case, the optimized entity parameter sequence 420 corresponds to an efficient frontier defined by the Markowitz Model for the data entity.

In some embodiments, an optimized entity parameter sequence 420 is an entity attribute sequence associated with a predicted optimal outcome-time feature for a data entity. In some examples, the optimized entity parameter sequence 420 is generated by solving the real-time optimization model 418 for a particular data entity. For instance, the optimized entity parameter sequence 420 may include an entity attribute sequence that lies above an efficient frontier defined by a Markowitz model generated for the condition-specific entity cohort 406. In some examples, the optimized entity parameter sequence 420 may represent the most cost-effective sequence of treatments for a data entity at a particular point in time that achieves a quality-of-life and risk tolerance threshold for the data entity.

In some embodiments, the performance of one or more prediction-based actions 422 is initiated based on the optimized entity parameter sequence 420. In some embodiments, a prediction-based action 422 is a response to an optimized entity parameter sequence 420 for a data entity. A prediction-based action 422 may include a physical action, such as an automatic administration of a medical treatment (e.g., by automatically injecting a particular dosage of medication, such as insulin for a diabetic condition), a scheduling of a medical treatment, a facilitation of a prescription, and/or the like. In addition, or alternatively, the prediction-based action 422 may include a computing operation, such as providing one or more instructions to automate a medical device (e.g., to record/transmit data in response to a parameter modification 424, etc.), initiating a display of information through a dynamic user interface (e.g., a recommendation to a physical through a physical portal, etc.), and/or the like. In some examples, the prediction-based action 422 may initiate a physical action through a computing operation (e.g., by recommending a treatment to a physician, etc.). In some embodiments, in response to solving the real-time optimization model 418 (e.g., finding an efficient frontier of a Markowitz model, etc.), a selected optimized entity parameter sequence 420 (e.g., set of treatment options, etc.) may be made available to a provider computing entity, such as a CDS tool), to provide one or more treatment recommendations to a physician.

In some embodiments, responsive to the one or more prediction-based actions 422, one or more parameter modifications 424 are received for the data entity based on the optimized entity parameter sequence 420. In some examples, the one or more prediction-based actions 422 may include a treatment recommendation for the condition and the one or more parameter modifications 424 may be responsive to a selection of the treatment recommendation. In some examples, the graph-based data structure 402 may be updated based on the one or more parameter modifications 424.

In some embodiments, the parameter modification 424 a modification to a current entity parameter sequence for a data entity. A parameter modification 424, for example, may be performed to update a current entity parameter sequence for a data entity to the optimized entity parameter sequence 420 for the data entity. In a healthcare prediction domain, for example, a parameter modification 424 may include a performance of a new and/or modified set of treatments for a condition.

In some examples, the optimized entity parameter sequence 420 and/or one or more parameter modifications 424 may be logged for a data entity by adding one or more graph nodes to the graph-based data structure 402. In this manner, the parameter modifications 424 may provide a feedback loop for refining future iterations of the real-time optimization model 418. In some examples, the parameter modifications 424 and/or one or more resulting outcome-time features 410 may be leveraged as ground truths for training a deep learning model through back-propagation of errors. In such a case, the efficient frontier of the real-time optimization model 418 may include a feature engineered for the deep learning model configured to generate an optimized entity parameter sequence 420 for a data entity based on an entity attribute sequence of the data entity. By way of example, the deep learning model may include a neural network, decision tree, and/or the like that may form a machine-learning pipeline with the real-time optimization model 418. The real-time optimization model 418 may form a first, feature engineering layer of the machine-learning pipeline and the deep learning model may form a second, prediction layer of the machine-learning pipeline.

In some embodiments, a simulated recovery feature is generated, using the real-time optimization model 418, for the data entity based on the one or more parameter modifications 424. In some embodiments, the simulated recovery feature is a predictive data element that describes a future positive impact to an outcome-time feature 410 based on a parameter modification 424. A simulated recovery feature, for example, may describe one or more future costs that are avoided by a parameter modification 424. By way of example, in a healthcare prediction domain, a simulated recovery feature may describe a future reduction in a total cost of care due to a medical treatment or intervention.

In some embodiments, a simulated recovery feature is aggregated from the condition-specific entity cohort 406. For example, the simulated recovery features may be generated based on historical positive impact correlated to a particular parameter modification 424. In some examples, the historical positive impact may be aggregated from a plurality of granular, time-based, cost avoidance events (e.g., a future treatment avoided by an earlier treatment, etc.). In some examples, the simulated recovery feature may include a plurality of potential recovery features respectively corresponding to the granular, time-based, cost avoidance events.

In some embodiments, an outcome-time feature for a particular data entity of the condition-specific entity cohort 406 is regenerated at a defined time frequency 412. In such a case, the operations of the present disclosure may be continuously performed to iteratively initiate new prediction-based actions 422 over time to efficiently account for observations across a prediction domain. At each stage of the process, an entire entity attribute sequence may be considered for each data entity within a condition-specific entity cohort 406 by traversing the graph-based data structure 402 as the graph-based data structure 402 is dynamically updated.

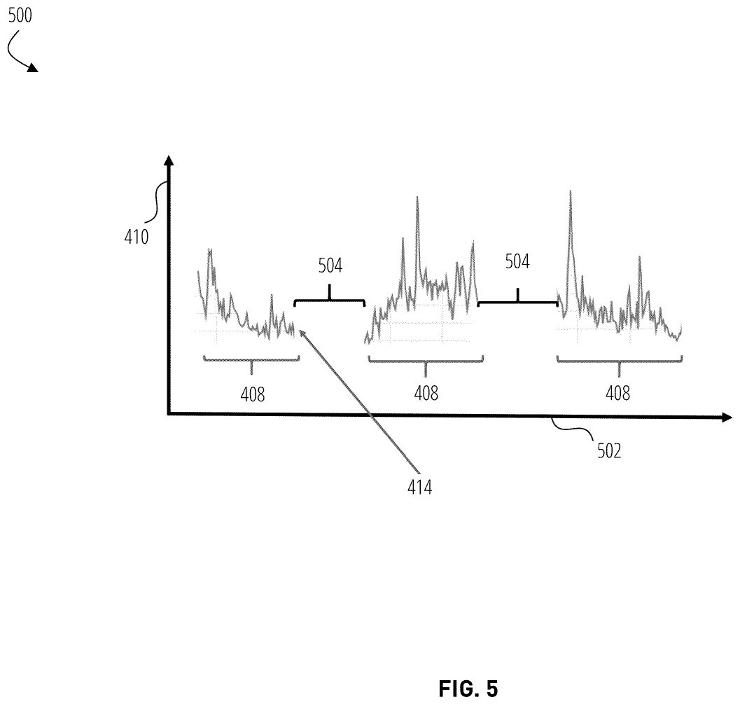

In some embodiments, in the event of gaps in an entity attribute sequence 408, one or more correctional operations are performed to simulate one or more correction attributes 414 to complete the entity attribute sequence 408. For example, the correction attributes 414 may be interpolated from the graph-based data structure 402 and/or one or more third-party data sources 416 to simulate a complete entity attribute sequence 408 for each data entity within the condition-specific entity cohort 406 despite one or more potential gaps in recorded information. This allows for a complete analysis of a population and counteracts potential data discrepancies that may be common in different prediction domains, such as healthcare prediction domains in which data entities may freely switch coverages over one or more time periods. An example of one or more correctional operations is described in further detail with reference to FIG. 5.

FIG. 5 is an operational example 500 of an entity attribute sequence 408 in accordance with some embodiments discussed herein. As shown, in some examples, an entity attribute sequence 408 may include one or more temporal gaps 504. In some examples, the temporal gaps 504 may be identified and completed using one or more correction attributes 414. In some examples, an outcome-time feature for a data entity associated with the entity attribute sequence 408 may be generated by identifying the one or more temporal gaps 504 in the entity attribute sequence 408, interpolating one or more correction attributes 414 within the one or more temporal gaps 504, and generating the outcome-time feature based on the entity attribute sequence 408 and the one or more correction attributes 414.

In some embodiments, the temporal gap 504 is an unrecorded time period for a data entity. A temporal gap 504, for example, may include a period of time in which one or more attributes are missing from the entity attribute sequence 408. In some examples, a temporal gap 504 may identify a gap in knowledge for a data entity. The gap in knowledge may be due to a number of different factors. As an example, in a healthcare domain, a temporal gap 504 may identify a time period in which a patient is covered by a third-party insurance platform (or not covered at all).

In some embodiments, if a graph traversal identifies a temporal gap 504 (e.g., missing graph nodes and/or graph edges over a period of time, etc.) with a data entity's entity attribute sequence 408, one or more correction attributes 414 may be simulated to remediate the temporal gap 504.

In addition, or alternatively, in a healthcare prediction domain, an additional layer may be added to the graph-based data structure 402 to represent a “slowly-changing” layer. This may permit additional refinement in identification of patients who may have a piecewise claims history because an employer, or Veteran's Association, etc., may potentially change less frequently than the data entity changes insurance platforms.

In some embodiments, the correction attributes 414 are simulated attributes for a data entity. A correction attribute 414, for example, may include a simulated attribute for a temporal gap 504. In this manner, a plurality of correction attributes 414 may be simulated to complete an entity attribute sequence 408 by filling in one or more temporal gaps 504 of the entity attribute sequence 408. A correction attribute 414 may be generated using one or more interpolation techniques. The one or more interpolation techniques, for example, include generating correction attributes 414 based on relative data entities and/or digital twins for the data entity.

In some embodiments, the graph-based data structure 402 is expanded with a data entity standardized condition layer. The data entity standardized condition layer may represent a relative constant in a data entity's timeline (e.g., a healthcare journey, for example a Union or Veteran's Association). The relative constant may be aggregated from one or more time-based attributes corresponding to each data entity within a condition-specific entity cohort 406. In some examples, the one or more correction attributes 414 for a data entity may be interpolated from the data entity standardized condition layer. By way of example, an automated agent may interpolate (e.g., by randomly and/or targeted sampling from the data entity standardized condition layer) one or more correction attributes 414 for a data entity associated with one or more temporal gaps 504.

In addition, or alternatively, the one or more correction attributes may be interpolated from attributes of a plurality of related data entities and/or a digital twin to a data entity.

In some embodiments, the correction attributes 414 are interpolated by identifying one or more related data entities from the condition-specific entity cohort and simulating the one or more correction attributes 414 based on one or more entity attribute sequences corresponding to the one or more related data entities.

In some embodiments, a related data entity is a different data entity with one or more attributes that are similar to an entity attribute sequence 408 for a data entity. In some examples, a graph-specific interpolation methods may be leveraged to simulate one or more correction attributes 414 for a data entity based on attributes associated with one or more related data entities. In a healthcare prediction domain, for example, the related data entities may include one or more attributes that exhibit a similar disease trajectory and/or treatment pattern (e.g., entity parameter sequence) to a data entity. In some examples, the attributes of the related data entities may be aggregated to simulate one or more correction attributes 414 for the data entity. In some examples, the related data entities may be identified from a condition-specific entity cohort 406.

In some embodiments, the correction attributes 414 are interpolated by identifying, from a third-party data source, a digital twin corresponding to the particular data entity based on the entity attribute sequence and simulating the one or more correction attributes 414 based on the digital twin.

In some embodiments, the digital twin is a third-party data entity that corresponds to a data entity. A digital twin, for example, may include a different data entity from a third-party data source that includes one or more attributes that are similar to the data entity. In some examples, a similarity threshold (e.g., a number and/or specific sequence of matching attributes, etc.) may be used to identify a digital twin and/or a related data entity. The similarity threshold may be higher (e.g., requiring a greater similarity) for a digital twin relative to a related data entity.

In some examples, using a digital twin approach, a third-party data source may be accessed to identify a digital twin for a data entity. Once identified, attributes may be interpolated from the digital twin to generate one or more correction attributes 414 for the data entity.

In some embodiments, the third-party data source may be a data structure that includes a plurality of data entities that are separate from the plurality of data entities of the graph-based data structure. In a healthcare prediction domain, a third-party data source, for example, may include Patient-Level Information Costing (PLICs) data from a National Health Service, and/or any other third-party healthcare surveying data source.

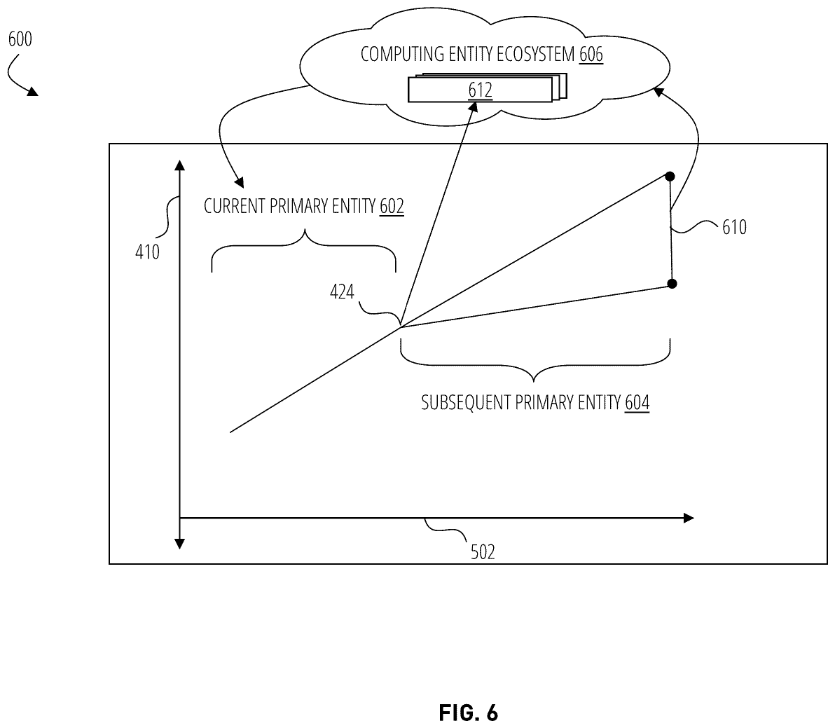

In some embodiments, one or more insights of the present disclosure may power recover attribution ecosystem. For example, the entity attribute sequence 408 and/or one or more predictive insights thereof may enable the predictive forecasting of one or more simulated recovery features for a data entity and/or a computing entity associated therewith. In some examples, the simulated recovery features may be monitored within a computing entity ecosystem to track and facilitate collaborative parameter modifications for a data entity over time. An example of a recovery attribution ecosystem is described in further detail with reference to FIG. 6.

FIG. 6 is an operational example 600 of a recovery attribution ecosystem in accordance with some embodiments discussed herein. The recovery attribution ecosystem may be facilitated by a computing entity ecosystem 606 and a plurality of recovery attribution tokens 612 generated, assigned, and shared across one or more computing entities of the computing entity ecosystem 606, such as a current primary entity 602 and a subsequent primary entity 604 for a data entity. In some examples, the recovery attribution tokens 612 may record (e.g., credit, etc.) a recovery feature 610 for a data entity that is achieved in response to a parameter modification 424. In this manner, positive impacts to the outcome-time feature 410 for a data entity may be tracked over time 502 and used to facilitate collaborative facilitation of an optimized entity parameter sequence for a data entity.

In some embodiments, access to data indicative of the simulated recovery feature is provided to the computing entity ecosystem 606. In some examples, the primary computing entity may be identified as a current primary entity 602 associated with a current relationship with the data entity. In some examples, one or more recovery attribution tokens 612 may be generated for the primary computing entity based on the one or more parameter modifications 424 and the simulated recovery feature. In some examples, the one or more recovery attribution tokens 612 may be assigned to the primary computing entity. In some examples, the one or more recovery attribution tokens 612 may be provided to a subsequent primary computing entity (e.g., subsequent primary entity 604) in response to a relationship modification of the data entity.

In some embodiments, a recovery attribution token 612 is a data element that is assigned to a current primary entity 602 in response to a parameter modification that results in one or more recovery features 610. By way of example, a recovery attribution token 612 may include a credit assigned to current primary entity 602 for a data entity. In some examples, the recovery attribution token 612 may be assigned for each of a plurality of granular, time-based, cost avoidance events. In some examples, the recovery attribution token 612 may initiate a value transfer in the event that a particular granular, time-based, cost avoidance event is avoided for a particular data entity while a subsequent primary entity 604 is responsible for the data entity.

In some embodiments, a relationship modification is a change between a current primary entity 602 and a subsequent primary entity 604. For example, in a healthcare prediction domain, a relationship modification may be a change in benefits from one insurance provider to another insurance provider.

Due to the ability to perform relationship modifications, negative impacts to an outcome-time feature 410 of a data entity may be encountered by a current primary entity 602 without encountering the future positive impacts on the outcome-time feature 410 that are a direct result of an action performed by the current primary entity 602. For example, continuing the healthcare example, future medical, financial, and quality-of-life deteriorations may be averted by modifying an entity parameter sequence for a data entity. These savings may come at an initial cost to the current primary entity 602, while benefitting a subsequent primary entity 604. This may create a “someone pays now for someone else saves later” conundrum that may have a negative impact on optimal entity parameter sequences for a data entity. Some embodiments of the present disclosure are directed to technical advances for addressing this challenge, among others.

In some embodiments, a computing entity is computing resource that is owned, operated, and/or otherwise associated with a primary entity for a plurality of data entities within a prediction domain. A computing entity, for example, may include one of a plurality of computing entities within the computing entity ecosystem 606.

In some embodiments, the computing entity ecosystem 606 is a plurality of computing entities within a prediction domain. A computing entity and computing entity ecosystem 606 depend on the prediction domain. In an example healthcare domain, the computing entity ecosystem 606 may correspond to a plurality of healthcare insurance platforms respectively operated by a different insurance provider, plan, and/or the like. In such a case, each computing entity may correspond to an at least partially distinctly operated healthcare insurance platform.

In some embodiments, the current primary entity 602 is a data element that describes a primary entity with a current relationship with a data entity. By way of example, in a healthcare domain, a current primary entity 602 may include a healthcare insurance platform that is currently (e.g., at a current time) primary payer for medical claims corresponding to a data entity.

In some embodiments, the subsequent primary entity 604 refers to a data element that describes a primary entity with a subsequent relationship with a data entity. By way of example, in a healthcare domain, a subsequent primary entity 604 may include a healthcare insurance platform that is subsequently (e.g., at a time after the current primary entity 602) assigned as a primary payer for medical claims corresponding to a data entity.

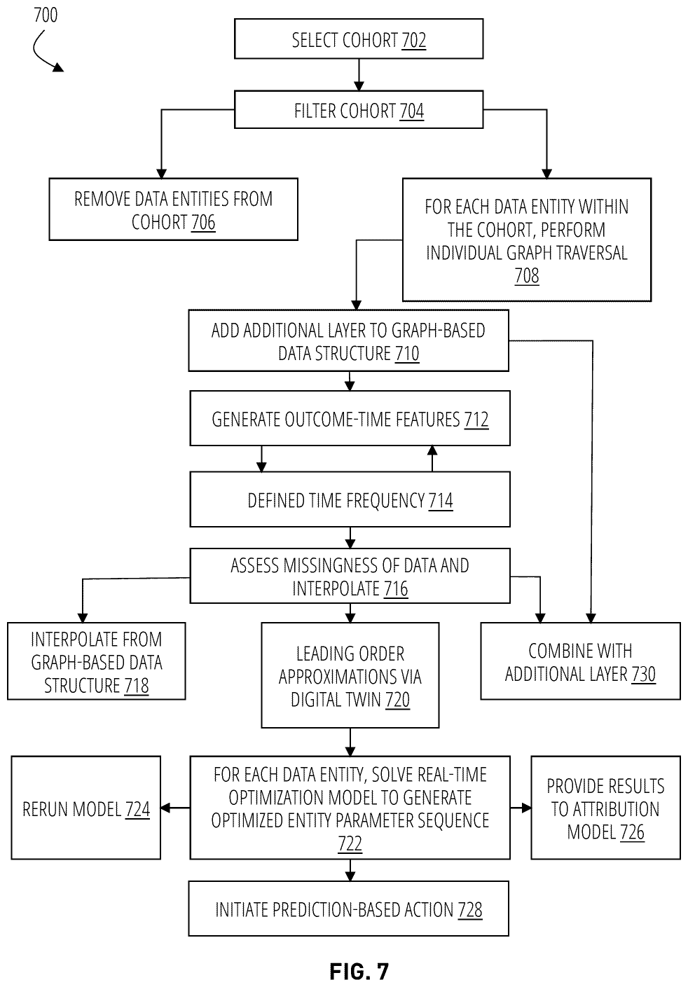

FIG. 7 is a flowchart diagram of an example process 700 for generating and initiating an optimized entity parameter sequence in accordance with some embodiments discussed herein. The flowchart depicts a parameter optimization process 700 for improving the optimized entity parameter sequence with respect to diverse use cases. The process 700 may be implemented by one or more computing devices, entities, and/or systems described herein. For example, via the various steps/operations of the process 700, the computing system 101 may leverage improved parameter modeling techniques to generate and evaluate optimized entity parameter sequences. By doing so, the process 700 enables the intelligent initiation of parameter modification and prediction-based actions that (i) automatically adapt to changes in a predictive domain and (ii) allow for the tracking and recapture of positive impacts over time.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 includes, at step/operation 702, selecting a cohort. For example, the computing system 101 may identify a condition-specific entity cohort for a data entity that is associated with (i) a condition and (ii) a primary computing entity within a computing entity ecosystem.

In some embodiments, the process 700 includes, at step/operation 704, filtering a cohort. For example, the computing system 101 may filter a cohort by verifying an identity of one or more data entities within the condition-specific entity cohort. At step/operation 706, the computing system 101 may remove unverified data entities from the condition-specific entity cohort.

In some embodiments, the process 700 includes, at step/operation 708, for each data entity within the cohort, performing an individual graph traversal. For example, the computing system 101 may traverse a graph-based data structure to generate an entity attribute sequence for each data entity within a condition-specific entity cohort. In some examples, the condition-specific entity cohort may be identified based on a graph-based data structure that includes a plurality of graph nodes in which each respective data entity of the condition-specific entity cohort corresponds to a graph node of the graph-based data structure. In some examples, the condition-specific entity cohort includes a plurality of data entities associated with the condition. In some examples, each of the plurality of entity attribute sequences corresponds to one or more patient characteristics of a particular data entity within the condition-specific entity cohort at a particular time. In some examples, each of the plurality of entity parameter sequences corresponds to a treatment plan to remediate the condition for the particular data entity at the particular time.

In some embodiments, the process 700 includes, at step/operation 710, adding an additional layer to a graph-based data structure. For example, the computing system 101 may add a slow changing layer to a graph-based data structure to catch data entities with frequent relationship modifications.

In some embodiments, the process 700 includes, at step/operation 712, generating an outcome-time feature. For example, the computing system 101 may generate an outcome-time feature of the plurality of outcome-time features for a particular data entity based on an entity attribute sequence corresponding to the particular data entity. In some examples, the computing system 101 may traverse the graph-based data structure to generate an outcome-time feature for a particular data entity of the condition-specific entity cohort. In some examples, each of the plurality of outcome-time features may correspond to a total cost of care for the particular data entity at the particular time.

In some embodiments, the process 700 includes, at step/operation 714, regenerating the outcome-time features at a defined time frequency. For example, the computing system 101 may regenerate the outcome-time feature for the particular data entity of the condition-specific entity cohort at the predefined time frequency.

In some embodiments, the process 700 includes, at step/operation 716, assessing an assess missingness of data and interpolating correction attributes. For example, the computing system 101 may identify one or more temporal gaps in the entity attribute sequence. In some examples, the computing system 101 may interpolate one or more correction attributes within the one or more temporal gaps. In some examples, the computing system 101 may generate the outcome-time feature based on the entity attribute sequence and the one or more correction attributes.

In some embodiments, the process 700 includes, at step/operation 718, interpolating correction attributes from the graph-based data structure. For example, the computing system 101 may identify one or more related data entities from the condition-specific entity cohort. The computing system 101 may simulate the one or more correction attributes based on one or more entity attribute sequences corresponding to the one or more related data entities.

In some embodiments, the process 700 includes, at step/operation 720, performing leading order approximations via a digital twin. For example, the computing system 101 may identify, from a third-party data source, a digital twin corresponding to the particular data entity based on the entity attribute sequence. The computing system 101 may simulate the one or more correction attributes based on the digital twin.

In some embodiments, the process 700 includes, at step/operation 730, combining the correction attributes and/or leading order approximations with the additional, slow changing layer. For example, the computing system 101 may generate one or more correction attributes in accordance with step/operation 718, step/operation 720, and/or step/operation 710.

In some embodiments, the process 700 includes, at step/operation 722, for each data entity, solving a real-time optimization model to generate an optimized entity parameter sequence. For example, the computing system 101 generate a real-time optimization model for the condition based on (i) a plurality of outcome-time features, (ii) a plurality of entity attribute sequences, and (iii) a plurality of entity parameter sequences corresponding to the condition-specific entity cohort. The computing system 101 may generate, using the real-time optimization model, an optimized entity parameter sequence for the data entity.

In some embodiments, the real-time optimization model is a Markowitz Model, and the optimized entity parameter sequence corresponds to an efficient frontier defined by the Markowitz Model for the data entity.

In some embodiments, the process 700 includes, at step/operation 724, rerunning the model. For example, the computing system 101 may rerun the model in the event that the optimized entity parameter sequence is not positioned above an efficient frontier of the real-time optimization model.

In some embodiments, the process 700 includes, at step/operation 726, providing the results to an attribution model. For example, the computing system 101 may provide the optimized entity parameter sequence and/or one or more parameter modification associated therewith to an attribution model. The attribution model may be configured to generate a simulated recovery feature for the optimized entity parameter sequence and/or one or more parameter modification associated therewith.

In some embodiments, the computing system 101 identifies a primary computing entity as a current primary entity associated with a current relationship with the data entity. The computing system 101 may generate one or more recovery attribution tokens for the first computing entity based on the one or more parameter modifications and the simulated recovery feature and assign the one or more recovery attribution tokens to the primary computing entity.

In some embodiments, the process 700 includes, at step/operation 728, initiating a prediction-based action. For example, the computing system 101 may initiate the performance of one or more prediction-based actions based on the optimized entity parameter sequence.

In some examples, responsive to the one or more prediction-based actions, the computing system 101 may receive one or more parameter modifications for the data entity based on the optimized entity parameter sequence. In some examples, the one or more prediction-based actions may include a treatment recommendation for the condition and the one or more parameter modifications are responsive to a selection of the treatment recommendation. In some embodiments, the computing system 101 updates the graph-based data structure based on the one or more parameter modifications.

In some examples, responsive to the one or more prediction-based actions, the computing system 101 may generate, using the real-time optimization model and/or the attribution model, the simulated recovery feature for the data entity based on the one or more parameter modifications, and provide access to data indicative of the simulated recovery feature to the computing entity ecosystem. In some examples, providing access to the data indicative of the simulated recovery feature may include providing one or more recovery attribution tokens to a subsequent primary computing entity in response to a relationship modification of the data entity.

Some techniques of the present disclosure enable the generation of action outputs that may be performed to initiate one or more real world actions to achieve real-world effects. The parameter modification techniques, for example, may be used, applied, and/or otherwise leveraged to initiate a physical action, including the injection of medication for a particular condition. For instance, the parameter modification may trigger the performance of actions at a client device, such as the display, transmission, and/or the like of data reflective of a new treatment. In some examples, the parameter modification may initiate, trigger, and/or the like one or more control instructions for providing the treatment to an individual.

In some embodiments, the optimized entity parameter sequence may trigger an alert, such as one or more treatment recommendations in a healthcare scenario. The alert may be automatically communicated to a user associated with the optimized entity parameter sequence. In addition, or alternatively, the optimized entity parameter sequence and/or the parameter modification may trigger an allocation of currency, such as in the form of a redeemable token (e.g., recovery attribution token, etc.), and/or the like.

In some examples, the computing tasks may include actions that may be based on a healthcare domain. A healthcare domain may include any environment in which computing systems may be applied to generate an optimized treatment plan and initiate the performance of computing tasks responsive to the optimized treatment plan. These actions may cause real-world changes, for example, by controlling a hardware component, providing alerts, interactive actions, and/or the like. For instance, actions may include the initiation of automated instructions across and between devices, automated notifications, automated scheduling operations, automated precautionary actions, automated security actions, automated data processing actions, automated treatment injection, and/or the like.

### VI. CONCLUSION

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.
Example 1. A computer-implemented method, the computer-implemented method comprising identifying, by one or more processors, a condition-specific entity cohort for a data entity that is associated with (i) a condition and (ii) a primary computing entity within a computing entity ecosystem; generating, by the one or more processors, a real-time optimization model for the condition based on (i) a plurality of outcome-time features, (ii) a plurality of entity attribute sequences, and (iii) a plurality of entity parameter sequences corresponding to the condition-specific entity cohort; generating, by the one or more processors and using the real-time optimization model, an optimized entity parameter sequence for the data entity; initiating, by the one or more processors, the performance of one or more prediction-based actions based on the optimized entity parameter sequence; and responsive to the one or more prediction-based actions, receiving one or more parameter modifications for the data entity based on the optimized entity parameter sequence; generating, using the real-time optimization model, a simulated recovery feature for the data entity based on the one or more parameter modifications; and providing access to data indicative of the simulated recovery feature to the computing entity ecosystem.
Example 2. The computer-implemented method of example 1, wherein the real-time optimization model is a Markowitz Model, and the optimized entity parameter sequence corresponds to an efficient frontier defined by the Markowitz Model for the data entity.
Example 3. The computer-implemented method of any of the preceding examples, wherein (i) the condition-specific entity cohort comprises a plurality of data entities associated with the condition, (ii) each of the plurality of entity attribute sequences corresponds to one or more patient characteristics of a particular data entity within the condition-specific entity cohort at a particular time, (iii) each of the plurality of entity parameter sequences corresponds to a treatment plan to remediate the condition for the particular data entity at the particular time, and (iv) each of the plurality of outcome-time features corresponds to a total cost of care for the particular data entity at the particular time.
Example 4. The computer-implemented method of any of the preceding examples, wherein the one or more prediction-based actions comprise a treatment recommendation for the condition and the one or more parameter modifications are responsive to a selection of the treatment recommendation.
Example 5. The computer-implemented method of any of the preceding examples, wherein providing access to data indicative of the simulated recovery feature to the computing entity ecosystem comprises identifying the primary computing entity as a current primary entity associated with a current relationship with the data entity; generating one or more recovery attribution tokens for the primary computing entity based on the one or more parameter modifications and the simulated recovery feature; and assigning the one or more recovery attribution tokens to the primary computing entity.
Example 6. The computer-implemented method of example 5, wherein the one or more recovery attribution tokens are provided to a subsequent primary computing entity in response to a relationship modification of the data entity.
Example 7. The computer-implemented method of any of the preceding examples, wherein the condition-specific entity cohort is identified based on a graph-based data structure that comprises a plurality of graph nodes and each respective data entity of the condition-specific entity cohort corresponds to a graph node of the graph-based data structure.
Example 8. The computer-implemented method of example 7, wherein an outcome-time feature for a particular data entity of the condition-specific entity cohort is generated by traversing the graph-based data structure.
Example 9. The computer-implemented method of example 8, further comprising updating the graph-based data structure based on the one or more parameter modifications.
Example 10. The computer-implemented method of any of examples 8 or 9, wherein the outcome-time feature for the particular data entity is regenerated at a predefined time frequency.
Example 11. The computer-implemented method of any of the preceding examples, wherein (i) an outcome-time feature of the plurality of outcome-time features is generated for a particular data entity based on an entity attribute sequence corresponding to the particular data entity, and (ii) generating the outcome-time feature comprises (a) identifying one or more temporal gaps in the entity attribute sequence, and (b) interpolating one or more correction attributes within the one or more temporal gaps, and (c) generating the outcome-time feature based on the entity attribute sequence and the one or more correction attributes.
Example 12. The computer-implemented method of example 11, wherein interpolating the one or more correction attributes comprises identifying one or more related data entities from the condition-specific entity cohort; and simulating the one or more correction attributes based on one or more entity attribute sequences corresponding to the one or more related data entities.
Example 13. The computer-implemented method of example 11 or 12, wherein interpolating the one or more correction attributes comprises identifying, from a third-party data source, a digital twin corresponding to the particular data entity based on the entity attribute sequence; and simulating the one or more correction attributes based on the digital twin.
Example 14. A computing system comprising memory and one or more processors communicatively coupled to the memory, the one or more processors configured to identify a condition-specific entity cohort for a data entity that is associated with (i) a condition and (ii) a primary computing entity within a computing entity ecosystem; generate a real-time optimization model for the condition based on (i) a plurality of outcome-time features, (ii) a plurality of entity attribute sequences, and (iii) a plurality of entity parameter sequences corresponding to the condition-specific entity cohort; generate, using the real-time optimization model, an optimized entity parameter sequence for the data entity; initiate the performance of one or more prediction-based actions based on the optimized entity parameter sequence; and responsive to the one or more prediction-based actions, receive one or more parameter modifications for the data entity based on the optimized entity parameter sequence; generate, using the real-time optimization model, a simulated recovery feature for the data entity based on the one or more parameter modifications; and provide access to data indicative of the simulated recovery feature to the computing entity ecosystem.
Example 15. The computing system of example 14, wherein the real-time optimization model is a Markowitz Model, and the optimized entity parameter sequence corresponds to an efficient frontier defined by the Markowitz Model for the data entity.
Example 16. The computing system of example 14 or 15, wherein (i) the condition-specific entity cohort comprises a plurality of data entities associated with the condition, (ii) each of the plurality of entity attribute sequences corresponds to one or more patient characteristics of a particular data entity within the condition-specific entity cohort at a particular time, (iii) each of the plurality of entity parameter sequences corresponds to a treatment plan to remediate the condition for the particular data entity at the particular time, and (iv) each of the plurality of outcome-time features corresponds to a total cost of care for the particular data entity at the particular time.
Example 17. The computing system of any of examples 14 through 16, wherein the one or more prediction-based actions comprise a treatment recommendation for the condition and the one or more parameter modifications are responsive to a selection of the treatment recommendation.
Example 18. The computing system of any of examples 14 through 17, wherein providing access to data indicative of the simulated recovery feature to the computing entity ecosystem comprises identifying the primary computing entity as a current primary entity associated with a current relationship with the data entity; generating one or more recovery attribution tokens for the primary computing entity based on the one or more parameter modifications and the simulated recovery feature; and assigning the one or more recovery attribution tokens to the primary computing entity.
Example 19. The computing system of example 18, wherein the one or more recovery attribution tokens are provided to a subsequent primary computing entity in response to a relationship modification of the data entity.
Example 20. One or more non-transitory computer-readable storage media including instructions that, when executed by one or more processors, cause the one or more processors to identify a condition-specific entity cohort for a data entity that is associated with (i) a condition and (ii) a primary computing entity within a computing entity ecosystem; generate a real-time optimization model for the condition based on (i) a plurality of outcome-time features, (ii) a plurality of entity attribute sequences, and (iii) a plurality of entity parameter sequences corresponding to the condition-specific entity cohort; generate, using the real-time optimization model, an optimized entity parameter sequence for the data entity; initiate the performance of one or more prediction-based actions based on the optimized entity parameter sequence; and responsive to the one or more prediction-based actions, receive one or more parameter modifications for the data entity based on the optimized entity parameter sequence; generate, using the real-time optimization model, a simulated recovery feature for the data entity based on the one or more parameter modifications; and provide access to data indicative of the simulated recovery feature to the computing entity ecosystem.

1. A computer-implemented method, the computer-implemented method comprising:
identifying, by one or more processors, a condition-specific entity cohort for a data entity that is associated with (i) a condition and (ii) a primary computing entity within a computing entity ecosystem;
generating, by the one or more processors, a real-time optimization model for the condition based on (i) a plurality of outcome-time features, (ii) a plurality of entity attribute sequences, and (iii) a plurality of entity parameter sequences corresponding to the condition-specific entity cohort;
generating, by the one or more processors and using the real-time optimization model, an optimized entity parameter sequence for the data entity;
initiating, by the one or more processors, the performance of one or more prediction-based actions based on the optimized entity parameter sequence; and
responsive to the one or more prediction-based actions:
receiving one or more parameter modifications for the data entity based on the optimized entity parameter sequence;
generating, using the real-time optimization model, a simulated recovery feature for the data entity based on the one or more parameter modifications; and
providing access to data indicative of the simulated recovery feature to the computing entity ecosystem.

2. The computer-implemented method of claim 1, wherein the real-time optimization model is a Markowitz Model, and the optimized entity parameter sequence corresponds to an efficient frontier defined by the Markowitz Model for the data entity.

3. The computer-implemented method of claim 1, wherein:
(i) the condition-specific entity cohort comprises a plurality of data entities associated with the condition,
(ii) each of the plurality of entity attribute sequences corresponds to one or more patient characteristics of a particular data entity within the condition-specific entity cohort at a particular time,
(iii) each of the plurality of entity parameter sequences corresponds to a treatment plan to remediate the condition for the particular data entity at the particular time, and
(iv) each of the plurality of outcome-time features corresponds to a total cost of care for the particular data entity at the particular time.

4. The computer-implemented method of claim 1, wherein the one or more prediction-based actions comprise a treatment recommendation for the condition and the one or more parameter modifications are responsive to a selection of the treatment recommendation.

5. The computer-implemented method of claim 1, wherein providing access to data indicative of the simulated recovery feature to the computing entity ecosystem comprises:
identifying the primary computing entity as a current primary entity associated with a current relationship with the data entity;
generating one or more recovery attribution tokens for the primary computing entity based on the one or more parameter modifications and the simulated recovery feature; and
assigning the one or more recovery attribution tokens to the primary computing entity.

6. The computer-implemented method of claim 5, wherein the one or more recovery attribution tokens are provided to a subsequent primary computing entity in response to a relationship modification of the data entity.

7. The computer-implemented method of claim 1, wherein the condition-specific entity cohort is identified based on a graph-based data structure that comprises a plurality of graph nodes and each respective data entity of the condition-specific entity cohort corresponds to a graph node of the graph-based data structure.

8. The computer-implemented method of claim 7, wherein an outcome-time feature for a particular data entity of the condition-specific entity cohort is generated by traversing the graph-based data structure.

9. The computer-implemented method of claim 8, further comprising:
updating the graph-based data structure based on the one or more parameter modifications.

10. The computer-implemented method of claim 8, wherein the outcome-time feature for the particular data entity is regenerated at a predefined time frequency.

11. The computer-implemented method of claim 1, wherein:
(i) an outcome-time feature of the plurality of outcome-time features is generated for a particular data entity based on an entity attribute sequence corresponding to the particular data entity, and
(ii) generating the outcome-time feature comprises:
(a) identifying one or more temporal gaps in the entity attribute sequence, and
(b) interpolating one or more correction attributes within the one or more temporal gaps, and
(c) generating the outcome-time feature based on the entity attribute sequence and the one or more correction attributes.

12. The computer-implemented method of claim 11, wherein interpolating the one or more correction attributes comprises:
identifying one or more related data entities from the condition-specific entity cohort; and
simulating the one or more correction attributes based on one or more entity attribute sequences corresponding to the one or more related data entities.

13. The computer-implemented method of claim 11, wherein interpolating the one or more correction attributes comprises:
identifying, from a third-party data source, a digital twin corresponding to the particular data entity based on the entity attribute sequence; and
simulating the one or more correction attributes based on the digital twin.

14. A computing system comprising memory and one or more processors communicatively coupled to the memory, the one or more processors configured to:
identify a condition-specific entity cohort for a data entity that is associated with (i) a condition and (ii) a primary computing entity within a computing entity ecosystem;
generate a real-time optimization model for the condition based on (i) a plurality of outcome-time features, (ii) a plurality of entity attribute sequences, and (iii) a plurality of entity parameter sequences corresponding to the condition-specific entity cohort;
generate, using the real-time optimization model, an optimized entity parameter sequence for the data entity;
initiate the performance of one or more prediction-based actions based on the optimized entity parameter sequence; and
responsive to the one or more prediction-based actions:
receive one or more parameter modifications for the data entity based on the optimized entity parameter sequence;
generate, using the real-time optimization model, a simulated recovery feature for the data entity based on the one or more parameter modifications; and
provide access to data indicative of the simulated recovery feature to the computing entity ecosystem.

15. The computing system of claim 14, wherein the real-time optimization model is a Markowitz Model, and the optimized entity parameter sequence corresponds to an efficient frontier defined by the Markowitz Model for the data entity.

16. The computing system of claim 14, wherein:
(i) the condition-specific entity cohort comprises a plurality of data entities associated with the condition,
(ii) each of the plurality of entity attribute sequences corresponds to one or more patient characteristics of a particular data entity within the condition-specific entity cohort at a particular time,
(iii) each of the plurality of entity parameter sequences corresponds to a treatment plan to remediate the condition for the particular data entity at the particular time, and
(iv) each of the plurality of outcome-time features corresponds to a total cost of care for the particular data entity at the particular time.

17. The computing system of claim 14, wherein the one or more prediction-based actions comprise a treatment recommendation for the condition and the one or more parameter modifications are responsive to a selection of the treatment recommendation.

18. The computing system of claim 14, wherein providing access to data indicative of the simulated recovery feature to the computing entity ecosystem comprises:
identifying the primary computing entity as a current primary entity associated with a current relationship with the data entity;
generating one or more recovery attribution tokens for the primary computing entity based on the one or more parameter modifications and the simulated recovery feature; and
assigning the one or more recovery attribution tokens to the primary computing entity.

19. The computing system of claim 18, wherein the one or more recovery attribution tokens are provided to a subsequent primary computing entity in response to a relationship modification of the data entity.

20. One or more non-transitory computer-readable storage media including instructions that, when executed by one or more processors, cause the one or more processors to:
identify a condition-specific entity cohort for a data entity that is associated with (i) a condition and (ii) a primary computing entity within a computing entity ecosystem;
generate a real-time optimization model for the condition based on (i) a plurality of outcome-time features, (ii) a plurality of entity attribute sequences, and (iii) a plurality of entity parameter sequences corresponding to the condition-specific entity cohort;
generate, using the real-time optimization model, an optimized entity parameter sequence for the data entity;
initiate the performance of one or more prediction-based actions based on the optimized entity parameter sequence; and
responsive to the one or more prediction-based actions:
receive one or more parameter modifications for the data entity based on the optimized entity parameter sequence;
generate, using the real-time optimization model, a simulated recovery feature for the data entity based on the one or more parameter modifications; and
provide access to data indicative of the simulated recovery feature to the computing entity ecosystem.
